(19) United States
(12) Patent Application Publication
(10) Pub. No.: US 2026/0276529 A1
(43) Pub. Date: Sep. 17, 2026

(54) RGB CAMERA SCANNED ILLUMINATION

(71) Applicant: TOMRA SORTING GMBH, Mülheim-Kärlich (DE)

(72) Inventor: Dirk BALTHASAR, Boppard (DE)

(73) Assignee: TOMRA SORTING GMBH, Mülheim-Kärlich (DE)

(21) Appl. No.: 19/470,396

(22) PCT Filed: Apr. 4, 2024
(86) PCT No.: PCT/EP2024/059222

§ 371 Date: Sep. 29, 2025

(30) Foreign Application Priority Data
Apr. 4, 2023 (EP) 23166520.9

(51) Int. Cl. G01N 21/31; G06T 7/00; H04N 23/56; H04N 23/71; H04N 23/72; H04N 23/73; H04N 23/75

(52) U.S. Cl. CPC G01N 21/31; G06T 7/0004; H04N 23/56; H04N 23/71; H04N 23/72; H04N 23/73; H04N 23/75; G01N 2201/0636; G01N 2201/105; G06T 2207/10016; G06T 2207/20212

(57) ABSTRACT

An inspection system for inspecting objects passing through an inspection area, which inspection area comprises at least a first elongated inspection zone having a longitudinal extension. The inspection system comprises an irradiation arrangement, a camera configured to provide a sequence of images of said at least a first inspection zone, a polygon mirror configured to rotate around a rotation axis and comprising a plurality of reflective surfaces arranged one after another around said rotation axis, wherein each reflective surface of said polygon mirror is configured to redirect optical radiation originating from said irradiation arrangement towards a portion only of said inspection area, which irradiated portion moves along said longitudinal extension of said at least a first elongated inspection zone from a first irradiated end to a second irradiated end of said at least a first elongated inspection zone once per reflective surface and revolution of said polygon mirror.

### TECHNICAL FIELD

The inventive concept described herein generally relates to an inspection system for inspecting objects passing through an inspection area and to a method for doing the same.

### BACKGROUND

There is high interest in the field of automated detection and analysis of objects, with applications in a wide range of industries. Sensor-based sorting systems are for example used in the recycling and waste management industry, where sorting and classification of objects are performed by machines where objects are supplied in bulk as a continuous stream of objects. One such machine is described in WO 2021/249698 A1, where properties of the objects are analysed by a spectroscopy system and a laser triangulation system. Classification and sorting of the objects are based on detected properties, e.g. resulting from the analysis performed by the spectroscopy system and/or laser triangulation system.

One very different system is described in US 2014/0333755 seemingly aimed at chemical analysis based on scanning a focused light, preferably a laser spot smaller than 1 mm, and capture the scattering characteristics of the reflected light. The scanning movement of the focused light beam is synchronized with the exposure time of the camera. According to this document more information may be acquired by adding further lasers of different wavelengths. The document also states that a higher number of scans, e.g. 2, during one exposure results in a lower signal to noise ratio.

It is many times desirable to increase the accuracy of the classification and sorting. At the same time, there is a rapid development is the field of Artificial Intelligence and Deep Learning. Thanks to these techniques, previously hard to sort objects, e.g. rolling objects and/or overlapping objects can be dealt with without compromising throughput and/or accuracy of the classification and sorting, i.e. by adjusting operation of the sensor-based sorting system. However, this requires images of sufficient quality and information content, for which dedicated high intensity illumination is required.

### SUMMARY

In view of the above, an object of the present inventive concept is to provide a compact and cost competitive system with preferably low energy consumption that enables acquisition of high quality images of objects passing through an inspection area. In relation to this invention the quality of an image may be increased by increasing e.g. resolution, contrast, sharpness, and/or by decreasing e.g. noise, distortion.

The invention is defined by the appended independent claims, with embodiments being set forth in the appended dependent claims, in the following description, and in the drawings.

According to a first aspect of the inventive concept, there is provided an inspection system for inspecting objects passing through an inspection area comprising:
an irradiation arrangement configured to emit optical radiation within a at least a first predetermined wavelength range,
a camera arrangement comprising a camera configured to provide a sequence of images of at least a first elongated inspection zone having a longitudinal extension, which at least a first elongated inspection zone comprises at least one elongated portion of said inspection area, and
a polygon mirror configured to rotate around a rotation axis and comprising a plurality of reflective surfaces arranged one after another around said rotation axis,
wherein
a field of view of said camera is static with respect to said inspection area,
each reflective surface of said polygon mirror is further configured to redirect optical radiation originating from said irradiation arrangement towards a portion only of said inspection area, which irradiated portion moves along said longitudinal extension of said at least a first elongated inspection zone from a first irradiated end to a second irradiated end of said at least a first elongated inspection zone once per reflective surface and revolution of said polygon mirror.

The present inventive concept is at least partly based on the realization that an irradiation arrangement which irradiates the inspection area via the polygon mirror is enough to enable a camera to provide high quality images, while being compact. An additional advantage is that is it may easily be integrated with existing inspection systems, i.e. share irradiation arrangement and polygon mirror with an inspection system of the type described for example in WO 2021/249698 A1.

The objects passing through the inspection area may be transported on a conveyor belt. Additionally or alternatively, the objects may be transported through the inspection area on a chute or slide, or in free fall.

The inspection area may be defined as a 2D area. For instance, the inspection area may be a portion of the conveyor belt or of the chute or slide on which the objects are transported through the inspection area.

The transportation direction of the objects passing through the inspection area may be orthogonal to the longitudinal extension of the inspection zone. Alternatively, the transportation direction of the objects passing through the inspection zone may deviate from the orthogonal in relation to the longitudinal extension of the inspection zone by at most 5°, at most 10°, at most 20°, or at most 30°.

The transportation speed of the objects passing through the inspection area may be selected in the interval of 0.3 m/s to 20 m/s. For example, the transportation speed may be 2.5 m/s, or the transportation speed may be 3 m/s, alternatively 8 m/s. When the objects are transported through the inspection area on a conveyor belt, the transportation speed of the objects may be understood as the conveyor belt speed.

The objects may be provided through the inspection area continuously or intermittently. The objects may be provided in the inspection area in a orderly sequence or disorderly or in bulk. At any given time, no object, a partial object, a single object, or a plurality of objects may be present in the inspection area. The objects passing through the inspection area may be referred to as a stream of objects.

When the objects are transported in free fall, the inspection area is an area coinciding with the path of the falling objects. In the context of this application, the expression “passing through an inspection area” is to be construed as passing through a space extending generally from said camera towards said inspection area. For example, any object passing through a space such that it passes through a field of view of said camera should be understood to be passing through the inspection area, irrespective of a distance between said object and said camera. In other words, objects of different heights may pass through the inspection area, and an object generally following the stream of objects but not touching the surface of the conveyor or chute or slide (because of vibrations or other disturbances) is still considered to be passing through the inspection area.

The images in the sequence of images may be stitched together to form a larger image. With coordination of the polygon mirror, camera and transportation speed of the objects, a continuous image of the stream of objects passing through the inspection area may thus be obtained.

The quality of images obtained is improved if the movement of the inspected objects is predictable, i.e. if the objects move only in the main transportation direction and at nominal transportation speed. Under certain conditions, individual objects may deviate from the nominal transportation speed. However, in sorting applications, objects are normally slower than the nominal transportation speed, if they deviate. Therefore, there is normally no information loss: if the object is slower than the transportation speed, it will appear in more images in the sequence of images.

It will be appreciated that motion detection and/or motion information of an object maybe be recorded as motion artifacts. Such motion artifacts may be translated to motion estimates using Artificial Intelligence (AI) including deep learning techniques. In more detail, the movement of an object (in case of deviation from nominal) may for instance be calculated by comparing two neighbouring images in the sequence of images and determining vertical and/or horizontal deviation of pixels e.g. reflecting a particular feature of the object.

The irradiation arrangement preferably comprises at least one irradiation/illumination source selected from the group comprising LEDs, halogen lamps, and/or lasers. For example, the irradiation source may be a broadband spectral source, such as a halogen light source. A suitable halogen light source may have a spectral distribution starting at about 400 nm and significantly decaying at about 2.5 μm. A maximum emission power May occur at about 1.3 μm. As an alternative, Xenon arc light sources may be used for an irradiation source. A shorter wavelength such as from 200 nm and above may be achieved by using a Xenon arc light source. As a further alternative, an LED light source may be used for an irradiation source.

Additionally, or alternatively, irradiation sources that are also suitable for spectroscopy may be used as an irradiation source. For example, for UV-Fluorescence spectroscopy LED light sources may be used to advantage. For mid infrared spectroscopy heating elements may be used to advantage. For high spatial and spectral resolution spectroscopy systems, Supercontinuum lasers may be used for an irradiation source. For high spatial and spectral resolution multispectral systems, lasers at multiple wavelengths may be used in combination. For highly spatial resolution optimized multispectral systems, LEDs and Pulsed LEDs may be used for an irradiation source. Different types of irradiation sources may be combined as well.

Additionally, or alternatively, the irradiation arrangement may be configured to emit optical radiation within at least a first wavelength range, or combination of wavelength ranges, forming a continuous or discontinuous band of wavelengths totalling at least 100 nm, or at least 200 nm, or at least 300 nm, or at least 500 nm, or at least 1000 nm, or at least 2000 nm. Use of broad wavelength bands and a camera sensitive to this wavelength band is advantageous as it provides a higher information content in the resulting image, compared to e.g. when a monochromatic light source is used.

According to at least one exemplifying embodiment, said at least a first elongated inspection zone has a longitudinal extension and a transversal extension.

In general, in the context of this invention, each elongated inspection zone has a longitudinal extension and a transversal extension.

According to at least one exemplifying embodiment, said camera has a plurality of sensor pixel lines and is configured to capture images of said at least a first elongated inspection zone, wherein, during said capturing, each one of said at least a first elongated inspection zone covers a plurality of sensor pixel lines. Additionally or alternatively, the camera is arranged such that each one of said at least a first elongated inspection zone covers a plurality of sensor pixel lines.

In general, the transversal extension of an elongated inspection zone may be orthogonal to the longitudinal extension of the same inspection zone and/or transversal to the extension of one of said sensor pixel lines.

The camera may be configured to capture images of the at least a first elongated inspection zone, and for each image captured, the elongated inspection zone is captured by a plurality of sensor pixel lines.

In other words, the camera may be configured to capture images of each elongated inspection zone, wherein during said capturing, each elongated inspection zone covers a plurality of sensor pixel lines.

In configurations where there said at least a first elongated inspection zone comprises a plurality of elongated inspection zone (e.g., spatially separate, or partially overlapping inspection zones), each elongated inspection zone may be captured by a subset of the plurality of sensor pixel lines.

According to an example, the camera may capture images of the plurality of inspection zones simultaneously or substantially simultaneously dependent e.g. on the capacity of the camera, whereby a plurality of sequences of images is provided, each image in a sequence of images of one inspection zone being captured at the same time as a corresponding image in a sequence of images of another inspection zone.

According to an example, the camera may capture images of the plurality of inspection zones sequentially, whereby a plurality of sequences of images is provided, each image in the respective sequences of images being captured at a different point in time.

According to at least one exemplifying embodiment, each image in said sequence of images is a representation of at least a portion of said objects, or at least a portion of one object, or at least one whole object, when present in said at least a first elongated inspection zone.

In other words, each image in said sequence of images may be representation of at least a portion of said objects, or at least a portion of one object, or at least one whole object, when present in the respective elongated inspection zone.

Thus depending on the size of an object present in an elongated inspection zone, an image in the sequence of images of this elongated inspection zone may be a representation of a portion of said object or a representation of the whole of said object present in the elongated inspection zone. Where a plurality of objects are present in an elongated inspection zone, an image in the sequence of images of this elongated inspection zone may comprise a representation of respective portions of a first subset of objects and/or a representation of the respective whole object of a second subset of objects present in the elongated inspection zone.

According to at least one exemplifying embodiment, the representation of at least a portion of said objects, or at least a portion of one object, or at least one whole object, is a photographic representation. The term photographic representation of an object refers to a representation of the object corresponding to what would see and that a person would intuitively interpret using his or her cognitive functions. For example, when looking at FIG. 6, one intuitively interprets the image as a flattened empty food container provided with text and a container with some food. The height determination is made without the presence of any laser line or the like.

Said representation is optionally a hyperspectral representation of the object, i.e. a representation acquired by hyperspectral imaging, or a hyperspectral camera preferably in combination with an irradiation suitable for hyperspectral imaging.

The representation, or the photographic representation, may be provided e.g. in color, or grayscale or in any other format returned from the camera. For example, in a camera operating in grayscale all pixels may have substantially the same sensitivity to the received light, while in a camera operating in colour different groups of pixels may be sensitive to different wavelength ranges; e.g. one group of pixels are more sensitive to red-light (or wavelength around red-light), one group of pixels are more sensitive to green-light (or wavelength around green-light) and one group of pixels are more sensitive to blue-light (or wavelength around blue-light). This sensitivity may be achieved by each group of pixels being provided with a different filter, centered around e.g. red, green and blue light respectively; and this filter may have e.g. have a flat top transmission profile or a gaussian filter profile. In general there are cameras that are configured to operate inside and/or outside the visual wavelength rage and these cameras may be set up in a similar way as described above; i.e. all pixels may have substantially the same sensitivity to the received irradiation or different groups of pixels may be sensitive to different wavelength ranges e.g. by being provided by a filter or by any other means known to the person skilled in the art.

According to at least one exemplifying embodiment, the camera may be a grayscale camera, or an RGB camera, or a SWIR (short-wave infrared) camera, or an RGB+SWIR camera, hyperspectral camera or a camera with multiple filter elements.

According to at least one exemplifying embodiment, said irradiated portion covers the entire transversal extension of said at least a first elongated inspection zone.

In other words, said irradiated portion may cover the entire transversal extension of each elongated inspection zone when each image of the respective elongated inspection zone is captured.

Thus, for each image in said sequence of images, as the irradiated portion moves along said longitudinal extension of each elongated inspection zone from the first irradiated end to the second irradiated end, the entire two-dimensional extension of each elongated inspection zone is irradiated.

The irradiated portion may extend beyond the transversal extension of the at least a first elongated inspection zone on one or both sides. Alternatively, the irradiated portion is confined to the transversal extension of the at least a first elongated inspection zone on one or both sides.

In other words, the irradiated portion may extend beyond the transversal extension of each elongated inspection zone on one or both sides when each image of the respective elongated inspection zone is captured. Alternatively, the irradiated portion is confined to the transversal extension of each elongated inspection zone on one or both sides, when each image of the respective elongated inspection zone is captured.

According to at least one exemplifying embodiment, said irradiated portion covers at most 2%, or at most 5%, or at most 10%, or at most 15%, or at most 20%, or at most 30% of the longitudinal extension of the at least a first elongated inspection zone.

In other words, said irradiated portion may cover at most 2%, or at most 5%, or at most 10%, or at most 15%, or at most 20%, or at most 30% of the longitudinal extension of each elongated inspection zone.

The longitudinal extension of each elongated inspection zone may correspond to the width of the object stream. Alternatively, the width of the object stream may be larger than the longitudinal extension of each elongated inspection zone and a plurality of inspection system may be combined to inspect the entire width of the object stream as discussed below.

Thus, according to at least one example, the inspection system for inspecting objects passing through an inspection area comprises
an irradiation arrangement (5) configured to emit optical radiation within a at least a first predetermined wavelength range,
a camera arrangement (16) comprising a camera (6) configured to provide a sequence of images of at least a first elongated inspection zone (4) having a longitudinal extension and a transversal extension, which at least a first elongated inspection zone (4) comprises at least one elongated portion of said inspection area (3), and
a polygon mirror (7) configured to rotate around a rotation axis (R) and comprising a plurality of reflective surfaces (8) arranged one after another around said rotation axis (R),
wherein
a field of view (9) of said camera (6) is static with respect to said inspection area (3),
each reflective surface (8) of said polygon mirror (7) is further configured to redirect optical radiation originating from said irradiation arrangement towards a portion (10) only of said inspection area (3), which irradiated portion (10) moves along said longitudinal extension of said at least a first elongated inspection zone (4) from a first irradiated end (11) to a second irradiated end (12) of said at least a first elongated inspection zone (4) once per reflective surface (8) and revolution of said polygon mirror (7),
wherein the camera (6) is configured to capture said sequence of images at a predetermined frame rate, such that an exposure time of each image in said sequence of images corresponds to the time required for said irradiated portion (10) to move along the longitudinal extension of said at least a first elongated inspection zone (4) from the first irradiated end (11) to the second irradiated end (12) of the at least a first elongated inspection zone (4),
wherein said camera has a plurality of sensor pixel lines and is configured to capture said images of said at least a first elongated inspection zone (4), wherein said transversal extension of each one of said at least a first elongated inspection zone covers a plurality of pixel lines,
wherein each image in said sequence of image is a representation of at least a portion of said objects when present in said at least a first elongated inspection zone (4), and
wherein said irradiated portion (10) covers the entire transversal extension of said at least a first elongated inspection zone (4).

According to at least one example, the inspection system for inspecting objects passing through an inspection area comprises
an irradiation arrangement (5) configured to emit optical radiation within a at least a first predetermined wavelength range,
a camera arrangement (16) comprising a camera (6) configured to provide a sequence of images of at least a first elongated inspection zone (4) having a longitudinal extension and a transversal extension, which at least a first elongated inspection zone (4) comprises at least one elongated portion of said inspection area (3), and
a polygon mirror (7) configured to rotate around a rotation axis (R) and comprising a plurality of reflective surfaces (8) arranged one after another around said rotation axis (R),
wherein
a field of view (9) of said camera (6) is static with respect to said inspection area (3),
each reflective surface (8) of said polygon mirror (7) is further configured to redirect optical radiation originating from said irradiation arrangement towards a portion (10) only of said inspection area (3), which irradiated portion (10) moves along said longitudinal extension of said at least a first elongated inspection zone (4) from a first irradiated end (11) to a second irradiated end (12) of one of, or all of, said at least a first elongated inspection zone (4) once per reflective surface (8) and revolution of said polygon mirror (7),
wherein the camera (6) is configured to capture said sequence of images at a predetermined frame rate, such that an exposure time of each image in said sequence of images corresponds to the time required for said irradiated portion (10) to move along the longitudinal extension of one of said at least a first elongated inspection zone (4) from the first irradiated end (11) to the second irradiated end (12) of the at least a first elongated inspection zone (4),
wherein said camera has a plurality of sensor pixel lines and is configured to capture said images of said at least a first elongated inspection zone (4), wherein said transversal extension of each one of said at least a first elongated inspection zone covers a plurality of pixel lines,
wherein each image in said sequence of image is a representation of at least a portion of said objects when present in said at least a first elongated inspection zone (4), and
wherein said irradiated portion (10) covers the entire transversal extension of said at least a first elongated inspection zone (4).

According to at least one exemplifying embodiment, said irradiation arrangement is configured to provide a substantially uniform irradiation of said irradiated portion.

This may provide an even distribution of light over the two-dimensional extension of the at least a first elongated inspection zone over the exposure time of an image.

According to one example U′=E(minimum)/E(maximum) for the irradiation portion is at least 40% or at least 50% or at least 60%, where U is a first measure of uniformity and E is illumination measured in Lux and the irradiation is illuminating a reference surface. Additionally or alternatively, U″=E(minimum)/E(average) for the irradiation is at least 60% or at least 75% or at least 90%, where U″ is a second measure of uniformity and E is illumination measured in Lux the irradiation is illuminating a reference surface.

According to an example, the intensity variation between the brightest and darkest spot in at least 40%, or at least 50%, or at least 60%, or at least 70%, or at least 80%, of the irradiated portion may be at most 60%, or at most 50%, or at most 40%, or at most 30%, or at most 20%.

According to at least one exemplifying embodiment, the camera is configured to capture said sequence of images at a predetermined frame rate, such that an exposure time of each image in said sequence of images corresponds to the time required for said irradiated portion to move along the longitudinal extension of said at least a first elongated inspection zone from the first irradiated end to the second irradiated end of the at least a first elongated inspection zone.

In other words, the exposure time depends on the rotation speed of the polygon mirror, as well as on the number of reflective surfaces on the polygon mirror. The rotation speed of the polygon mirror may be selected in the range of 10 rpm to 20 000 rpm. As an example, the rotation speed of the polygon mirror may be 1440 rpm. With a polygon mirror comprising ten reflective surfaces, the irradiation spot will be scanned across the inspection zone 14.400 times per minute. The camera is then configured to capture images at a frame rate of 240 fps, giving an exposure time of each image of ≈4 ms.

In more detail the rotation speed on the polygon mirror may be selected in the interval of 10-100 rpm, 100-200 rpm, 200-300 rpm, 300-400 rpm, 400-500 rpm, 500-600 rpm, 600-700 rpm, 700-800 rpm, 800-900 rpm, or 900-1000 rpm, 100-10000 rpm or more or in an interval formed by any combination of the above specified revolution speed intervals.

For a particular configuration of the inspection system, i.e. for a particular distance between the polygon mirror and the main plane of the inspection area, a rotation speed of the polygon mirror corresponds to a speed of the irradiation spot along the extension of the inspection zone. The speed of the irradiation spot may be referred to as the scanning speed. The rotation speed of the polygon mirror may also advantageously be selected such that the scanning speed is high compared to the transportation speed of the objects passing through the inspection area. As an example, the scanning speed may be up to 200 times higher than the transportation speed. Preferably, the scanning speed is at least 10 times higher than the transportation speed, or 50 times higher than the transportation speed, or 100 times higher than the transportation speed. The table below presents the scanning speed at different rotation speeds of the polygon mirror:

| Scan | Polygon | mirror | Lines per | Scan |
|---|---|---|---|---|
| range [m] | rpm | faces | second | speed [m/s] |
| 0.6 | 10 | 10 | 1.67 | 1 |
| 0.6 | 1400 | 10 | 233 | 140 |
| 0.6 | 3000 | 10 | 500 | 300 |
| 0.6 | 20000 | 10 | 3333 | 2000 |

With a transportation speed of 3 m/s, the polygon mirror would typically operate at 1400-3000 rpm. As seen in the table above, this gives a scan speed of 140-300 m/s. The scan speed may thus be two orders of magnitude higher than the transportation speed.

Thus, for each exposure, the at least a first elongated inspection zone is irradiated in a scanning motion in one direction from one end to the other. During one exposure, each particle in the inspection zone is irradiated only for a short time. In particular, the time each particle is illuminated is shorter than the exposure time of one image. This enables the inspection system to obtain generally sharp images.

According to at least one exemplifying embodiment, the inspection system further comprises a trigger element associated with each reflective surface of the polygon mirror, wherein the system is configured such that said trigger element triggers said camera to start the exposure of each image in said sequence of images when said irradiated portion is at the first irradiated end of said at least a first elongated inspection zone, thus synchronizing said camera and said polygon mirror.

This ensures that the polygon mirror and the camera are synchronized throughout operation of the system.

The inspection system may comprise a trigger detector detecting a change in an electric/magnetic field caused by said trigger element or the trigger detector may be a pin diode detecting the passing of said trigger element.

According to at least one exemplifying embodiment, said camera is an area scan camera.

The camera is e.g. an RGB area scan camera or a graylevel camera, the camera may comprise a sensor with the light sensitive elements are arranged in a matrix.

As discussed above, the camera may have a plurality of sensor pixel lines. For example, the camera may be configured to capture each image in the sequence of image with at least 10 lines, or at least 12 lines, or at least 15 lines, or at least 20 lines, or at least 25 lines, or at least 30 lines, or at least 40 lines, or at least 50 lines, or at least 60 lines, or at least 70 lines, or at least 80 lines. Thus, the transversal extension of each inspection zone may be captured by the camera within the range of 10-80 lines, or a number of lines within any range having end points chosen among the examples given above.

The total number of sensor pixel lines of the camera may be at least 200, or at least 500, or at least 1000, or at least 1200, or at least 1500, or at least 2000, or at least 2500 lines. Thus, the camera may be configured to capture different inspection zones (i.e., spatially separate, or partially overlapping inspection zones) with different sets of sensor pixel lines.

Each elongated inspection zone may, for example, have a transversal extension of at least 5 mm, or at least 8 mm, or at least 10 mm, or at least 12 mm, or at least 16 mm, or at least 20 mm, or at least 40 mm. Each elongated inspection zone may, for example, have a transversal extension of at most 20 mm or at most 40 mm or at most 60 mm or at most 100 mm. In configurations with a plurality of elongated inspection zones, each elongated inspection zone may have the same transversal extension, or different transversal extensions.

Thus, according to at least one exemplifying embodiment, the irradiated portion may have a transversal extension of at least 5 mm, or at least 8 mm, or at least 10 mm, or at least 12 mm, or at least 16 mm, or at least 20 mm, or at least 40 mm or at least 60 mm.

According to at least one exemplifying embodiment, the irradiated portion may have a longitudinal extension of at least 5 mm, or at least 8 mm, or at least 10 mm, or at least 12 mm, or at least 16 mm, or at least 20 mm, or at least 25 mm, or at least 30 mm, or at least 40 mm, or at least 50 mm, or at least 60 mm. The irradiated portion may have a longitudinal extension of at most 200 mm, or at most 150 mm, or at most 120 mm, or at most 80 mm, or at most 60 mm, or at most 50 mm, or at most 40 mm, or at most 30 mm, or at most 20 mm.

According to at least one example, an elongated inspection zone having a transversal extension of 16 mm may be captured by 20 sensor pixel lines of the camera. This may provide high resolution images. Different combinations of numbers of sensor pixel lines and transversal extension of an elongated inspection zone are possible.

An area scan camera enables effective integration of the light provided by the irradiation arrangement. For example, the camera may be configured with a region of interest of 1280×20 pixels. Since the camera is viewing 20 lines at once, light provided by the irradiation arrangement may be more effectively used. In contrast, a line scan camera in the same position would have a shorter exposure time for each line, to acquire an image of the same area (20 lines) during the same time. To obtain bright enough images, this would have to be compensated by higher intensity light provided by the irradiation arrangement. Thus, the present invention enables high quality images with lower intensity illumination. The high quality of the images is enhanced by the static field of view of the camera.

According to at least one exemplifying embodiment, said camera arrangement further comprises an aperture element having an aperture delimiting said camera's field of view of said inspection area, which aperture element further comprises a white reference target arranged in said at least a first elongated inspection zone between said first and second irradiated ends of said at least a first elongated inspection zone.

Additionally or alternatively, said aperture element further comprises a dark reference target arranged in said at least a first elongated inspection zone before said first irradiated end or after said second irradiated end of said at least a first elongated inspection zone along said longitudinal extension.

Continuous calibration of e.g. the light source or the detector is thus provided. Moreover, the system is thus provided with built-in calibration. The white reference target and/or dark reference target are/is preferably fixedly arranged in said at least a first elongated inspection zone. The white and/or dark reference target may thus be arranged to be in the region of interest of said camera independently of the objects passing through the inspection area. As an example, the white and/or dark reference target may be arranged on an aperture element or attached to a frame in the vicinity of said aperture element, e.g. within 20 cm, or 10 cm, or 5 cm, or 3 cm, or 1 cm therefrom. The white and/or dark reference target is alternatively not arranged on any aperture element, but e.g. arranged to the side of the transportation means.

According to one example, the white reference target is illuminated by said illumination arrangement, while the dark reference target is not illuminated by said illumination arrangement. Continuous white and dark calibration may thus be provided. The dark reference target and the white reference target may for example be a surface painted or coated black or white, respectively (at least in the relevant wavelength range or at least in one or more predetermined wavelength ranges).

According to at least one exemplifying embodiment, the white reference target covers at least the entire transversal extension of the at least a first elongated inspection zone.

According to at least one exemplifying embodiment, the white reference target extends at least over the entire transversal extension of the irradiated portion or the transversal extension of the at least a first elongated inspection zone, when the irradiated portion irradiates the white reference target.

According to at least one exemplifying embodiment, said aperture comprises an optical window and said camera is further configured to provide an image of one or both of:
a relevant first part of said field of view, thus enabling detection of contamination on said optical window; and
a relevant second part of said field of view, said image of a relevant second part of said field of view being optionally taken while said irradiation arrangement is switched off, thus enabling detection of external light pollution.

Said first part and said second part of said field of view may optionally be the same.

Reporting of a contamination state of the optical window is thereby enabled. This information may for example be used to plan maintenance shifts and reduce maintenance effort by avoiding unnecessary cleaning. In sorting applications, a lower contamination level leads to better sorting results.

The first and/or second part of said field of view may be the full field of view of the camera. The first and/or second part of said field of view may comprise the entire aperture, or may comprise only a portion of the aperture. The first and/or second part of said field of view may comprise at least said at least a first elongated inspection zone.

The inspection area may provide a dark background for such an image. For example, the conveyor belt, on which objects are transported through the inspection area, may be black or at least of a dark colour.

Normally, the field of view (number of pixels) required for determining contamination over the relevant part of the optical window is larger compared to (the number of pixels of) the elongated inspection zone. Therefore, when providing an image of said relevant first part of said field of view, which image is taken while the irradiation arrangement is switched on, the exposure time is preferably chosen such that contamination on the optical window is made visible by the illumination.

Preferably, no objects should be present in the inspection area to improve the contamination detection, as a dark background increases the visibility of the contaminations. Detection may also be improved by additional image processing, such as for example gamma correction. Additionally, or alternatively, other image processing techniques, such as sharpness analysis, or analysis of multiple/differential images may be used to improve contamination detection. If objects are present in the inspection area additional image processing may be required.

External light pollution, especially strong light pollution, may be detected in images taken while the irradiation arrangement is switched on. The location of the at least a first elongated inspection zone within the field of view of the camera being known, light detected by the camera in other areas of the field of view may originate from external sources.

When providing an image of the relevant second part of the field of view taken while the irradiation arrangement is switched off, all light that is detected by the camera is exclusively caused by external sources.

Light pollution can potentially lead to reduced performance errors in sorting applications. Detecting light pollution is advantageous in inspection systems comprising a spectrometer system for material detection and/or analysis. Analysis of the external light pollution may be used to install means for shielding the inspection system from straylight like sheets, and/or compensating for the same by means of software algorithm.

According to at least one exemplifying embodiment, the inspection system further comprises a control unit configured to estimate motion of the objects and/or tracking a trajectory of the objects when the objects are passing through said at least one elongated inspection zone.

The control unit may be a single control unit or a plurality of control units. The control unit may control the equipment of the system. The control unit may control associated equipment, such as for example transportation means and/or ejection means. The control unit may comprise a processing unit adapted to process and or analyse the sequence of images of the at least a first elongated inspection zone. The control unit may estimate motion of the objects and/or track a trajectory of the objects when the objects are passing through said at least a first elongated inspection zone. Motion estimation can be based on vertical and or horizontal deviation in pixels or features between respective images in the sequence of images.

In an alternative exemplifying embodiment, motion estimation can be achieved through detected motion artifacts. Such motion artifacts may be translated to motion estimates using Artificial Intelligence (AI) including deep learning techniques. Said estimated movement and/or trajectory may provide more precise ejection. Said estimated movement may be used to compensate for movement artifacts in the images, thereby providing higher quality images.

According to at least one exemplifying embodiment, said at least a first elongated inspection zone comprises at least a first and a second elongated inspection zone and said camera is configured to provide a respective sequence of images of each one of said at least a first and a second elongated inspection zones.

This may provide for more effective and/or more accurate motion tracking of the objects. In turn a more precise ejection may be enabled.

The inspection system may be configured such that the irradiation spot, when it moves along the longitudinal extension of first elongated inspection zone from the first irradiated end to the second irradiated end of the first elongated inspection zone, also moves along the longitudinal extension of the second inspection zone. In other words, when the irradiation spot covers a portion of the first inspection zone, it also covers a corresponding portion of the second inspection zone. In yet other words, the polygon mirror redirects optical radiation from the irradiation arrangement simultaneously to the first elongated inspection zone and to the second elongated inspection zone.

According to at least one exemplifying embodiment, said at least a first elongated inspection zone comprises a plurality of elongated inspection zones,
said polygon mirror is configured to redirect said optical radiation towards each one said elongated inspection zones in said plurality of elongated inspection zones once per revolution of said scanning element,
each one of said plurality of reflective surfaces is configured to redirect, once per revolution of said polygon mirror, said optical radiation towards a respective one of said plurality of elongated inspection zones, and
said camera is configured to provide a respective sequence of images of each respective elongated inspection zone in said plurality of elongated inspection zones.

A larger part of the inspection area may thus be included in the images. Having a plurality a inspection zones may also provide for more accurate motion tracking of objects.

According to at least one exemplifying embodiment, said polygon mirror has a set of surface normals, wherein each one of said surface normals is a center surface normal of a respective one of said plurality of reflective surfaces and wherein each one of said surface normals in said set of surface normals has a different inclination angle to said rotation axis compared to the other surface normals in said set of surface normals.

Such a polygon mirror as described in relation to this exemplifying embodiment may be referred to as a multizone polygon mirror, as the optical irradiation may be directed to at least two different inspection zones of the inspection area(s).

The respective inclination angles may be selected within an interval of ±1°, ±2°, ±3°, ±4°, ±5°, ±6°, ±7°, ±8°, ±9°, ±10°, ±12°, ±15°, ±20°, or ±40°. The interval that the respective inclination angles may be selected within may optionally exclude ±0°, or may optionally exclude ±0.1°, or may optionally exclude ±0.4°, may optionally exclude ±1°.

In such a configuration, the polygon mirror may comprise at least two reflective surfaces which are angled with respectively different inclination angles. Said optical radiation may thus be directed towards at least two different inspection zones of the inspection area. Two, a plurality, or all reflective surfaces of said polygon mirror may be angled with respectively different inclination angles to said rotation axis.

According to at least one exemplifying embodiment, the inspection system further comprises at least one additional irradiation arrangement configured to emit optical radiation within a second predetermined wavelength range towards said inspection area.

The additional irradiation is not redirected by the polygon mirror, i.e. the optical elements used for redirecting, focusing and/or collimating the additional irradiation does not include the polygon mirror discussed above. The additional irradiation arrangement may irradiate a point, line or area coinciding with the area illuminated by the irradiation redirected the polygon mirror, or a point, line or area spatially separated from the area illuminated by the irradiation redirected the polygon mirror.

The additional irradiation arrangement may be arranged on the same side of the object stream as the irradiation arrangement which irradiates the polygon mirror, and irradiate this side of the object stream. Alternatively, the additional irradiation arrangement may be arranged on the opposite side of the object stream as the irradiation arrangement which irradiates the polygon mirror, and adapted to irradiate this opposite side of the object stream e.g. when the objects are in free fall or through a translucent layer. Optionally, a first part of the additional irradiation arrangement may be arranged on the same side of the object stream as the irradiation arrangement which irradiates the polygon mirror, an irradiate this side of the stream; while a second part of the additional irradiation arrangement may be arranged on the opposite side of the object stream as the irradiation arrangement which irradiates the polygon mirror, and this second part of the irradiation arrangement may irradiate this opposite side of the stream.

Said second predetermined wavelength range may be one or a combination of the ultraviolet, visible, near infrared and infrared wavelength range. The second predetermined wavelength range may be different than the first predetermined wavelength range or the second predetermined wavelength range may partly overlap with the first predetermined wavelength range. The second predetermined wavelength range may completely overlap with the first predetermined wavelength range. In other words, said irradiation arrangement and the at least one additional irradiation arrangement may be configured to emit optical radiation with the same or partly overlapping wavelength ranges. Said irradiation arrangement and the at least one additional irradiation arrangement may be configured to emit optical radiation in distinct wavelength ranges.

The additional irradiation arrangement may be arranged to directly or indirectly irradiate the at least a first elongated inspection zone or a second elongated inspection zone. The additional irradiation arrangement may be arranged on the same side of the main plane of the inspection area as the first irradiation arrangement or the additional irradiation arrangement may be arranged on the opposite side of the main plane of the inspection area compared to the first irradiation arrangement.

The additional irradiation arrangement may be configured to emit optical radiation in a continuous manner or in a pulsed manner.

According to one example, an additional irradiation arrangement may be arranged on the opposite side of the main plane of the inspection area compared to the polygon mirror and configured to irradiate a portion of the inspection area in a synchronized manner with the polygon mirror.

According to at least one exemplifying embodiment, the inspection system further comprises a spectrometer system having at least one detector, which at least one detector is configured to receive and detect optical radiation within a predetermined detection wavelength, which optical radiation is at least one of emitted, reflected and scattered by and/or transmitted through an object passing through said inspection area, wherein said at least one detector is preferably a spectrometer adapted to detect optical radiation selected from the group comprising UV, visible light, IR, NIR, or a combination thereof.

In particular, the optical radiation reflected or scattered by the object passing through the inspection area may originate from the irradiation arrangement and have been directed to the object by the polygon mirror. The inspection system may thus advantageously use the irradiation arrangement to irradiate the objects passing through the inspection zone both for the purpose of the camera and for the purpose of the detection system.

Preferably, the optical radiation emitted, reflected or scattered by, or transmitted through the object passing through the inspection area, is redirected to the detector system by said polygon mirror.

Such a system, combining a camera arrangement with a scanned spectroscopy system sharing the same irradiation arrangement may reduce or minimise the CO₂ footprint of the system, as well as operating costs.

According to at least one exemplifying embodiment, the inspection system further comprises at least one image processing unit configured to combine the images in said sequence of images to form an output comprising a representation of at least one object passing through said inspection area.

In more detail, an object passing through the inspection area may be larger than the at least a first elongated inspection zone. Thus, such an object is larger than what can be captured in a single image in the sequence of images. By combining the images in said sequence of images, an output comprising a representation of at least one object passing through the inspection area may be obtained. In particular, an output comprising a representation of at least one whole object passing through the inspection area may be obtained.

In configurations where each image in the sequence of image is a photographic representation as discussed above, the output may comprise a photographic representation of the at least one object passing through the inspection area.

In configurations where each image in the sequence of image is a hyperspectral representation as discussed above, the output may comprise a hyperspectral representation of the at least one object passing through the inspection area.

According to a second aspect of the present inventive concept, there is provided a system comprising multiple inspection systems, each inspection system being configured as described in connection to the first aspect and/or in embodiments or text related thereto. At least two or all of the inspection systems may be identical to each other, or each may be set up differently. In more detail, the respective polygon mirrors of the inspection systems are arranged so the respective irradiated portions of the inspection systems are spatially separated from each other along the inspection zones, i.e. when redirected from the respective first irradiated end to the second irradiated end of the respective elongated inspection zones.

By synchronising e.g. a first and second inspection system with each other, e.g. in response to the detected position of the respective trigger element, the inspections systems may be configured so that the optical radiation from one system does not disturb the other system. This may, dependent on the optical set up, also be of importance when a multizone polygon mirror is used. If a multizone polygon mirror is used, and the first inspection system redirects the optical radiation towards an area in the vicinity of the field of view of the second system, while the second system redirects the optical radiation towards an area in the vicinity of the field of view of the first system this may result in light contamination between the first and the second inspection system. Consequently, it is preferred that the respective irradiated portions of the inspection systems are spatially separated from each other when redirected from the respective first irradiated end to the second irradiated end of the respective elongated inspection zones; and optionally also directed sustainably in parallel, so that when the first inspection system redirects the optical radiation toward an inspection zone at one lateral end so does the second inspection system, i.e. the second inspection system also redirects the optical radiation toward the same lateral end—this lateral end e.g. being arranged to the right as seen in the transport direction. Similarly, when the first inspection system redirects the optical radiation toward an inspection zone at the other lateral end so does the second inspection system, i.e. the second inspection system also redirects the optical radiation toward the other lateral end—this lateral end being arranged to the left as seen in the transport direction according to this example.

The expression “light contamination” should be understood as optical radiation, originating from an irradiation arrangement of one inspection system and scattered or reflected by the objects passing through the inspection area, being captured by the camera of another inspection system. Thus, the system is configured such that the irradiation spots of different inspection systems do not interfere with each other, i.e. do not overlap.

Having multiple inspection systems may be advantageous for example if the inspection zone of a single inspection system is narrower than the stream of objects to be inspected. If one inspection system only inspects e.g. a quarter of the width of the stream, four identical systems can be used in parallel to cover the whole width of the stream.

According to a third aspect of the present inventive concept, there is provided a method for inspecting objects passing through an inspection area by an inspection system according to the first aspect wherein the method comprises:
redirecting, by a reflective surface of said polygon mirror, optical radiation originating from said irradiation arrangement towards a portion of said inspection area,
rotating said polygon mirror causing said irradiated portion to move along said longitudinal extension of said at least a first elongated inspection zone from said first irradiated end to said second irradiated end of said at least a first elongated inspection zone once per reflective surface and revolution of said polygon mirror, and
providing, by said camera, a sequence of images of said at least a first elongated inspection zone.

According to an alternative, a method for inspecting objects passing through an inspection area according to the third aspect comprises:
providing:
   at least a first elongated inspection zone (4) comprising at least a portion of said inspection area (3), said at least a first elongated inspection zone (4) having a longitudinal extension and a transversal extension,
   at least one object and passing said at least one object through said inspection area,
   an irradiation arrangement (5) configured to emit optical radiation within at least a first wavelength range,
   a camera arrangement comprising a camera (6) having a plurality of sensor pixel lines, and where a field of view (9) of said camera (6) is static with respect to said inspection area (3)
   a polygon mirror (7) configured to rotate around a rotation axis (R) and comprising a plurality of reflective surfaces (8) arranged one after another around said rotation axis (R),
   at least one image processing unit,
emitting, by said irradiation arrangement, optical radiation within said at least a first predetermined wavelength range,
redirecting, by a respective one of said reflective surfaces (8) of said polygon mirror (7), optical radiation originating from said irradiation arrangement (5) towards a portion (10) only of said inspection area, wherein said irradiated portion (10) covers the entire transversal extension of said at least a first elongated inspection zone (4),
rotating said polygon mirror (7) and thereby causing said irradiated portion (10) to move along said longitudinal extension of said at least a first elongated inspection zone (4) from a first irradiated end (11) to a second irradiated end (12) of one of, or all of, said at least a first elongated inspection zone (4) once per reflective surface and revolution of said polygon mirror (7),
capturing, by said camera (6), a sequence of images of said at least a first elongated inspection zone (4), where
   during said capturing, said transversal extension of each one of said at least a first elongated inspection zone (4) covers a plurality of said sensor pixel lines,
   each image in said sequence of images is a representation of at least a portion of said objects when present in said at least a first elongated inspection zone (4),
   each image in said sequence of images is captured with an exposure time corresponding to the time required for said irradiated portion (10) to move along the longitudinal extension of one of said at least a first elongated inspection zone (4) from said first irradiated end (11) to said second irradiated end (12) of said at least a first elongated inspection zone (4), and
combining, by said at least one image processing unit, the images in said sequence of images to form an output comprising a representation of the at least one object passing through said inspection area.

Providing at least one object and passing said at least one object through said inspection area may comprise providing and passing a stream, or row, of objects through the inspection area. In more detail, the objects passing through the inspection area may be transported as described in connection with the first aspect of the present inventive concept.

The method according to the third aspect may thus suitably be carried out with an inspection system as described in connection with the first aspect or a system according to the second aspect. It should be understood that any features and embodiments of the first aspect may, as far as it is compatible with the method, be implemented in the method according to the third aspect.

According to at least one exemplifying embodiment, the method further comprises capturing, by said camera, said sequence of images at a predetermined frame rate, such that an exposure time of each image in said sequence of images corresponds to the time required for said irradiated portion to move along the longitudinal extension of said at least a first elongated inspection zone from the first irradiated end to the second irradiated end of the at least a first elongated inspection zone.

According to at least one exemplifying embodiment, the inspection system comprises at least one image processing unit, and the method further comprises combining, by said at least one image processing unit, the images in said sequence of images to form an output comprising a photographic representation or a hyperspectral representation of at least one object passing through said inspection area.

According to at least one exemplifying embodiment, the method further comprises performing a white reference calibration for each image in said sequence of images, said white reference calibration being performed with respect to a white reference target arranged in said at least a first elongated inspection zone.

According to at least one exemplifying embodiment, said inspection area further comprises at least a second elongated inspection zone and the method further comprises providing respective sequences of images of each one of said at least a first and a second elongated inspection zones.

According to at least one exemplifying embodiment, said inspection system further comprises a spectrometer system having at least one detector configured to receive and detect optical radiation within a predetermined detection wavelength range, which optical radiation is at least one of emitted, reflected and scattered by and/or transmitted through an object passing through said inspection area, the method further comprising redirecting said optical radiation towards said at least one detector, wherein said optical radiation is preferably redirected via said polygon mirror.

According to at least one exemplifying embodiment, said camera arrangement comprises an aperture element having an aperture delimiting said camera's field of view of said inspection area, said aperture comprising an optical window, and the method further comprises:
providing, by said camera, an image of a relevant first part of said field of view, and
analyzing said image of said first part of said field of view to detect contamination on said optical window.

According to at least one exemplifying embodiment, the method further comprises:
providing, by said camera, an image of a relevant second part of said field of view, and
analyzing said image of said second part of said field of view to detect external light pollution,

Said first part and said second part of said field of view may optionally be the same

The method may optionally further comprise switching off said irradiation arrangement before said image of said second part of said field of view is taken.

Detection of contamination on the optical window of the aperture and/or detection of external light pollution may be performed during a break, i.e. outside of normal operation of the system, when no objects are passing through the inspection area. For example, a sequence of operation may be:
normal operation, i.e. the system providing a sequence of images of the at least a first elongated inspection zone,
break, i.e. no more objects passing through the inspection area,
detection of contamination on the optical window of the aperture,
switching off the irradiation arrangement,
detection of external light pollution,
resume normal operation.

According to a fourth aspect of the present inventive concept, there is provided a sorting system comprising:
an inspection system according to the first aspect,
transportation means for transporting said objects through said inspection area, wherein said transportation means is selected from a group comprising a conveyor belt, a chute or slide, a free fall path, and combinations thereof, and
an ejection arrangement for ejecting and sorting said objects into at least two different destinations, wherein said ejection arrangement is selected from a group comprising a robotic arm, mechanical fingers, air valves or nozzles, a conveyor belt, and combinations thereof.

The sorting system may thus comprise an inspection system as described in relation to the first aspect. It may optionally comprise a system as described in relation to the second aspect.

According to an alternative of the fourth aspect of the present inventive concept, there is provided an inspection system comprising:
an inspection system according to the first aspect or a system according to the second aspect, wherein each inspection system comprises at least one image processing unit configured to combine the images in said sequence of images to form an output comprising a representation of at least one object passing through said inspection area,
transportation means for transporting said objects through said inspection area, wherein said transportation means is selected from a group comprising a conveyor belt, a chute or slide, a free fall path, and combinations thereof,
an analysis unit configured to receive said output of said processing unit and analyze said representation of the at least one object passing through said inspection area.

According to one example, said inspection system is a sorting system, which sorting system further comprises:
an ejection arrangement for ejecting and sorting said objects into at least two different destinations based on said analysis of said representation, wherein said ejection arrangement is selected from a group comprising a robotic arm, mechanical fingers, air valves or nozzles, a conveyor belt, and combinations thereof.

Such a sorting system may enable optimal adjustment of the sensor-based sorting system based on the high quality images of objects. In at least one example embodiment, this may be achieved through estimation of the speed of the objects in the stream of objects and adapting an ejection process to the speed of each individual object in the stream of objects. This estimation may be performed in processing means comprised in the inspection system, or in processing means external to the inspection system. It may also be performed partly in the inspection system and partly in processing means external thereto.

According to at least an example embodiment of the inspection system or the sorting system, the analysis of said representation may comprise image processing and/or image recognition and/or deep learning techniques and/or machine learning techniques. In other words, an output comprising a representation of at least one object passing through said inspection area may be used for learning a machine to recognise different objects (potato or rock), classify objects according to different classifiers (good or decayed; red or blue) e.g. by use of a neural network. Said representation is optionally a photographic representation or optionally a hyperspectral representation of the object.

According to at least an example embodiment, the sorting system further comprises a control unit configured to estimate motion of the objects and/or tracking a trajectory of the objects when the objects are passing through said at least one elongated inspection zone. The control unit is configured to control said transportation means and/or said ejection arrangement based on said estimated motion and/or tracked trajectory.

This may provide more precise ejection by the ejection arrangement and/or a compensation for movement artifacts in the images to provide a higher quality of the sequence of images. As stated above, the compensation may be achieved by an adjustment of the transportation means, additionally or alternatively a higher image quality may also be achieved by, based on the estimation of the speed and direction and by use of image processing, compensate for this motion in the images.

### BRIEF DESCRIPTION OF THE DRAWINGS

Aspects of the present inventive concept and some non-limiting embodiments, including particular features and advantages, will now be further described with reference to the drawings, in which:

FIG. 1 is perspective schematic view of a sorting system provided with an inspection system according to an embodiment of the invention,

FIG. 2 is a perspective schematic view of an embodiment of the inspection system,

FIG. 3 is a schematic view of an embodiment of the inspection system,

FIG. 4a-c are schematic illustrations of an inspection area according to different embodiments,

FIG. 5 shows a polygon mirror having reflective surfaces with different orientations,

FIG. 6 shows an example of a sequence of images obtained by an inspection system according to the present invention,

FIGS. 7a-b show an example of a sequence of images obtained by an inspection system according to the present invention.

FIG. 8 is a schematic illustration of a system comprising multiple inspection systems,

FIGS. 9a-c show a photograph of the aperture element taken from a handheld camera, an image of the same aperture element taken by the camera of the inspection system, and the same image after processing, respectively,

FIGS. 10a-b show a photograph of the aperture element taken by a handheld camera, and an image of the same aperture element provided by the camera of the inspection system, respectively,

FIGS. 11a-c show a photograph of the inspection area, an image of the inspection area provided by the camera of the inspection system, and an image of the same inspection provided by the camera of the inspection system while a flashlight is directed towards the inspection area,

FIGS. 12a-c show further examples of a sequence of images obtained by an inspection system according to the present invention illustrating movement artifacts and the estimation of a movement vector.

### DETAILED DESCRIPTION

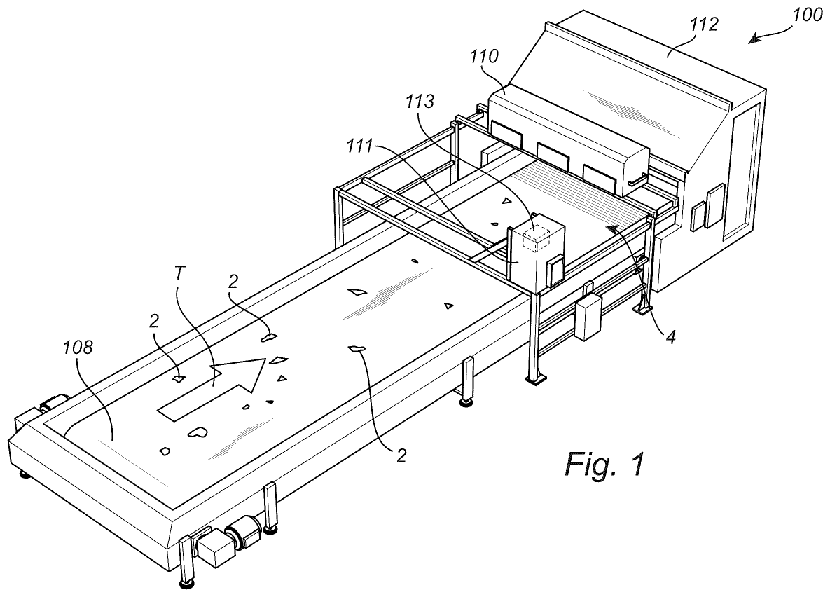

FIG. 1 shows a schematic view of an sorting system 100 provided with an inspection system 1 according to one embodiment of the invention. The sorting system 100 is adapted for compiling information about objects 2 and/or for classification of objects 2 in for example at least a first and a second class.

The inspection system 1 is adapted for inspecting objects 1 within an inspection area 3. The inspection system 1 may be adapted for inspecting objects within the inspection area 3 when said objects 2 are either stationary or moving. In a preferred embodiment, the inspection system 1 is adapted for inspecting objects 2 within the inspection area 2 when said objects 2 are continuously moving. Objects 2 to be inspected may be moving along a predetermined travel path that starts, ends, or passes through the inspection area 2. In the depicted sorting system 100 of FIG. 1, objects 2 travel along a travel path (direction T indicated by arrow) through the inspection area 2 by means of a conveyor system 108.

The objects 2 to be inspected may be moveable along said travel path by other means, wherein some non-limiting examples include e.g., by means of sliding (along a horizontal plane or an inclined plane) or freefalling. Hence, the conveyor system 108 of FIG. 1 is optional. The objects may be moved continuously or intermittently along the travel path. In FIG. 1, the inspection system 1 is illustrated as being arranged to inspect objects generally below the inspection system 1. The inspection system 1 is however not limited to only being arranged to inspect objects generally moving below the inspection system 1; the inspection system 1 may alternatively be arranged and/or oriented to be able to inspect objects generally passing to the side of the inspection system 1.

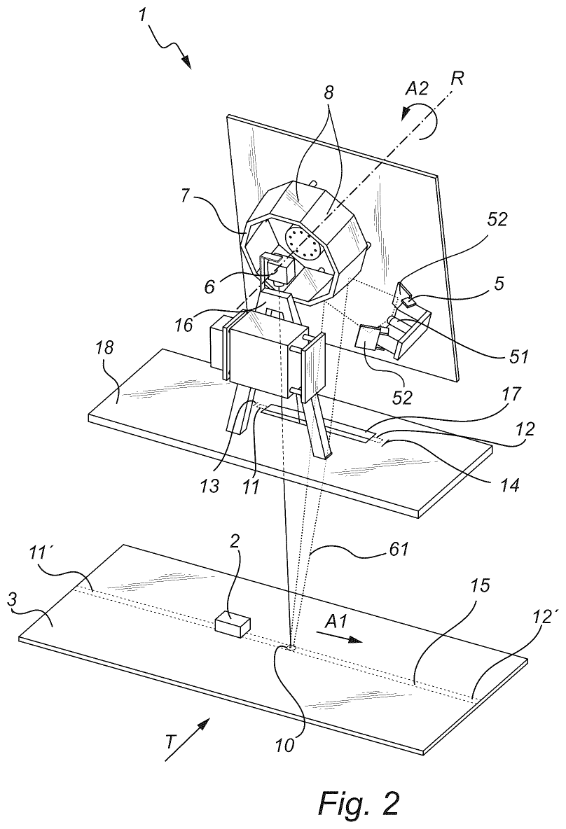

The inspection system 1 may comprise a housing 110 for housing at least some of the components of the inspection system 1. The inspection system 1 may be at least partly arranged in a housing 110. The housing 110 may be arranged above or to the side of the predetermined travel path of objects to be inspected. In FIG. 1, the housing 110 is arranged above the conveyor system 108. The inspection system 1 is discussed in more detail in reference to for example, FIG. 2 and other figures below.

The depicted sorting system 100 of FIG. 1 further includes an ejection arrangement 112 provided downstream of the inspection area 3. The ejection arrangement 112 is adapted to eject and sort the objects 2 into at least two different destinations. The ejection arrangement 112 however is optional.

The depicted sorting system 100 of FIG. 1 may further include a control cabinet 111. The control cabinet 111 may be arranged above the conveyor system 108. The control cabinet 111 includes equipment used for controlling the sorting system 100. The equipment typically includes a processing unit 113 or control unit for controlling the conveyor system 108, the ejection arrangement 112, and the equipment in the housing 110. The processing unit 113 is typically used to determine properties or a property of the objects 2 based on a measurement carried out by the equipment in the housing 110.

The inspection system 1 may comprise a control unit configured to estimate motion of the objects and/or tracking a trajectory of the objects when the objects are passing through the inspection zone 3. This may facilitate inspection of objects being inspected by the inspection system 1. This may improve accuracy of ejecting and sorting of objects 2 by the ejection arrangement 112.

An exemplifying embodiment of the inspection system 1 according to the present invention is shown in FIG. 2. The elements of the inspection system 1 shown in FIG. 2 may optionally be arranged in a housing, for example in the housing 110 of FIG. 1.

The inspection system 1 is adapted to inspect object 2 passing through an inspection area 3 and comprises:
an irradiation arrangement 5 configured to emit optical radiation within a first predetermined wavelength range,
a camera arrangement 16 comprising a camera 6 configured to provide a sequence of images of at least a first elongated inspection zone 4 having a longitudinal extension, which at least a first elongated inspection zone 4 comprises at least one elongated portion of said inspection area 3, and
a polygon mirror 7 configured to rotate around a rotation axis R and comprising a plurality of reflective surfaces 8 arranged one after another around said rotation axis R.

A field of view 9 of said camera 6 is static with respect to said inspection area 3. Each reflective surface 8 of said polygon mirror 7 is further configured to redirect optical radiation originating from said irradiation arrangement 5 towards a portion 10 only of said inspection area 3, which irradiated portion 10 moves along said longitudinal extension of said at least a first elongated inspection zone 4 from a first irradiated end 11 to a second irradiated end 12 of said at least a first elongated inspection zone 4 once per reflective surface 8 and revolution of said polygon mirror 7.

FIG. 2 shows the inspection area 3 and objects 2 transported therethrough in direction T, for example on a conveyor system 108 as depicted in FIG. 1. The main elements of the inspection system 1 are an irradiation arrangement 5, a polygon mirror 7, and a camera 6.

Here, the irradiation arrangement 5 comprises a light source 51 and optional partial parabolic mirrors 52 adapted to redirect optical radiation from the light source 51 to the polygon mirror 7. The irradiation arrangement 5 and the polygon mirror 7 are arranged such that optical radiation originating from the light source is redirected to the inspection area 3. The polygon mirror 7 redirects the optical radiation to a portion only of the inspection area 3, which portion is referred to as the irradiated portion 10. In FIG. 2, the path of the optical radiation from the polygon mirror 7 to the inspection area 3 is shown at 61.

In this example, the camera arrangement 16 comprises a camera 6 arranged to have a direct view of the inspection area 3. By direct view of the inspection area 3 it is meant that the camera views the inspection area without having optical radiation from objects 2 in the inspection area 3 redirected towards the camera 6 by means of optical elements, such as mirrors. Other configurations, in which the camera 6 views the inspection area 3 indirectly i.e. via optical elements, such as mirrors, are also possible. Here, the camera arrangement 16 also comprises an optional aperture element 18 having an opening 17. The camera 6 thus views the inspection area 3 through the opening 17 of the aperture element 18.

The polygon mirror 7 comprises ten reflective surfaces 8 arranged one after another around a rotation axis R. Polygon mirrors with fewer or more reflective surfaces could also be used. Here, all ten reflective surfaces 8 have the same angle with respect to the rotation axis R. In particular, the surface normal of each reflective surface 8 is orthogonal to the rotation axis R. The polygon mirror 7 is further arranged such that a projection of the rotation axis R on the inspection area 3 is parallel to the transportation direction T of the objects 2. With this arrangement, the irradiated portion 10 moves in the direction marked by arrow A1, upon rotation of the polygon mirror 7 about the rotation axis R in the direction marked by arrow A2. The irradiated portion 10 thus moves along an irradiated area 15 from a first irradiated end 11 to a second irradiated end 12. When the irradiated portion 10 reaches the second irradiated end 12, optical radiation from the irradiation arrangement 5 falls on the next reflective surface 8 of the polygon mirror, and the irradiated portion 10 starts a new scanning motion from the first irradiated end 11 of the illumination area 15; such a system is advantageous as it has a lower energy consumption compared to systems having e.g. a static illumination.

In the example configuration of FIG. 2, with the presence of an aperture element 18, the irradiated area 15 may comprise the full length of the aperture 17 in the direction of A1 as well as at least one part of the aperture element 18, on one side of the aperture 17, at least in the direction of A1, and the full length of the inspection area 3. Alternatively, the irradiated area 15 may comprise the full length of the aperture 17 in the direction of A1, as well as two parts of the aperture element 18, on both sides of the aperture 17 in the direction of A1, and the full length of the inspection area 3.

The optional aperture element 18 enables a white reference target and/or a dark reference target to be arranged within the field of view 9 of the camera 6 at a protected position in relation to the conveyor system 108. The reference targets are stationary, thus always in the field of view of the camera. There is no risk that the reference target interferes with the objects being transported through the inspection area 3 on the conveyor system 108.

The reference targets are optional. As such, configurations with no reference target, with both white 13 and dark 14 reference targets, or with only one of a white reference target 13 or dark reference target 14, or with alternative reference targets of another color or reflectivity are possible. The white 13 and/or dark 14 reference target may be on only one side of the aperture 17 or on both sides of the aperture 17. The white 13 and/or dark 14 reference target may be within the irradiated area 15 or partly in the irradiated area 15 or outside of the irradiated area.

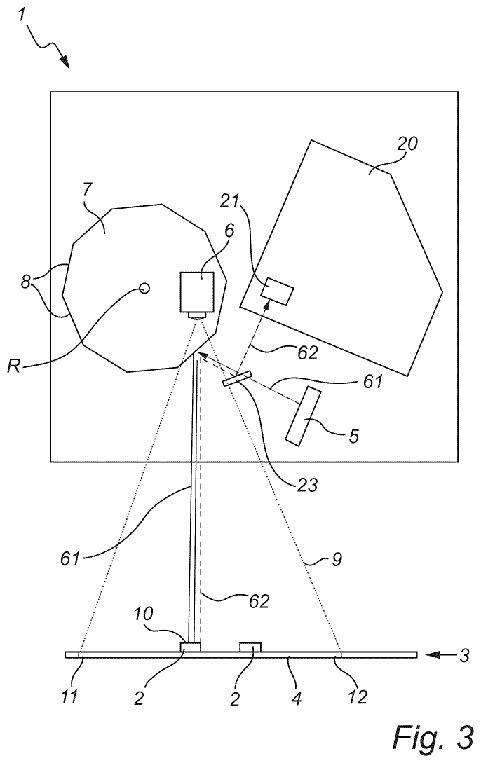

Another example embodiment of an inspection system 1 according to the present invention is schematically shown in side view in FIG. 3. Elements such as the irradiation arrangement 5 and the polygon mirror have been described in relation to FIG. 2. Here, only the camera 6 of the camera arrangement 16 is depicted and the optional aperture element 18 is omitted for clarity of the figure. The inspection area 3 is within the field of view 9 of the camera 6.

The irradiation arrangement 5 emits optical radiation which is directed to the polygon mirror 7 along the optical path 61: mirrors (not shown) of the irradiation arrangement direct the optical radiation towards the polygon mirror 7 and a reflective surface 8 of the polygon mirror 7 then reflects the optical reflection to create an irradiated portion 10 on the inspection area 3. In FIG. 3, the irradiated portion 10 is depicted approximately in a central position on the inspection area 3. Upon rotation of the polygon mirror 7 about the rotation axis R in the direction of arrow A2, the irradiated portion 10 will move in the direction of arrow A1.

In the example embodiment of FIG. 3, the inspection system 1 also comprises an optional spectrometer system 20 which is provided with at least one detector 21. The detector 21 is arranged and oriented to be able receive optical radiation originating from an object 2 arranged in the inspection area 3. The inspection system 1 is thus configured to receive and analyze optical radiation which is at least one of emitted, reflected, scattered by and/or transmitted through an object 2, which optical radiation is directed to the detector 21 along optical path 62, via the polygon mirror 7. Optionally, the optical path 62 comprises further optical elements, for example a folding mirror 23.

The detector 21 of the spectrometer system 20 is adapted to detect optical radiation within a predetermined wavelength range or ranges. Although the spectrometer system 20 is depicted as having one detector, the spectrometer system may also be provided with two or more detectors. Each detector may be adapted to detect optical radiation within different detection wavelength ranges, which detection wavelength ranges may be distinct or at least partially overlapping. The spectrometer system 20 is thus adapted to detect optical radiation selected from the group comprising UV, visible light, IR, NIR, or a combination thereof.

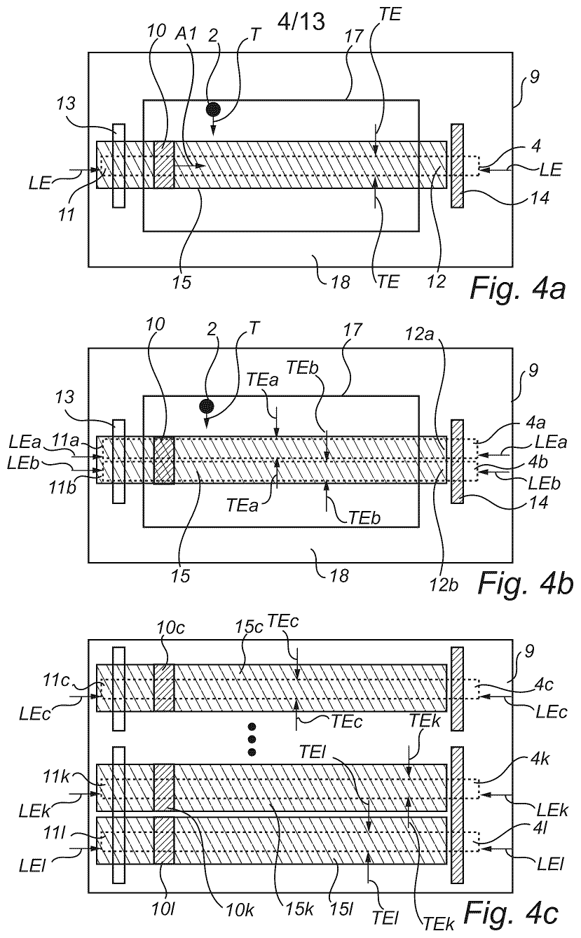

With reference to FIG. 4a, an example of the field of view 9 of the camera 6 is shown. The camera views the inspection area 3 through an aperture 17 in an optional aperture element 18. An object 2 to be inspected is being transported in the direction of arrow T. In this example configuration, the inspection system 1 is configured to have one elongated inspection zone 4, which is depicted with a dashed box. The elongated inspection zone 4 has a longitudinal extension, between arrows LE, and a transversal extension, between arrows TE. The elongated inspection zone 4 has a longitudinal extension that spans the entire length of the aperture 17. FIG. 4a shows how the elongated inspection zone 4 may optionally extend onto the aperture element 18 on both sides of the aperture 17. This allows the optional white reference target 13 and/or dark reference target 14 to be arranged on the aperture element 18. For a perspective view of the position, according to one example, of the aperture element 18 in relation to the inspection area 3, see FIG. 2.

The polygon mirror 7 (not shown in FIG. 4a) redirects optical radiation originating from the irradiation arrangement 5 towards a portion 10 only of the inspection area 3. As shown in FIG. 4a, the irradiated portion 10 covers a part of the elongated inspection zone 4. Notably, the irradiated portion 10 covers only a small part of the longitudinal extension of the elongated inspection zone 4, but its entire transversal extension. The irradiated portion 10 should extend at most 10% or at most 20% of the longitudinal extension of the elongated inspection zone 4. The arrow A1 indicates the direction in which the irradiated portion 10 moves upon rotation of the polygon mirror 7. The irradiated portion 10 repeatedly moves in a scanning motion within an irradiated area 15 from the first irradiated end 11 to the second irradiated end 12 of the elongated inspection zone 4.

As stated above, in this example configuration, the aperture element 18 comprises an optional white reference target 13 and an optional dark reference target 14. The white reference target is arranged at least partly in the elongated inspection zone 4 and the irradiated area 15. In other words, at least part of the white reference target 13 is irradiated during the scanning motion of the irradiated portion 10 and the irradiated part of the reference target 13 is within the elongated inspection zone 4. In the example of FIG. 4a, the white reference target spans the entire width of the elongated inspection zone 4 and of the irradiated area 15 in the transversal direction i.e. the direction of transport T. The white reference target may also be arranged to be completely inside the inspection zone 4 and to only partially cover the width of the inspection zone 4. Additionally, or alternatively, the white reference target may only partially, or not at all, cover parts of the irradiated area 15 that are not within the inspection zone 4.

The optional dark reference target 14 is in this example arranged on the opposite side of the aperture 17 in relation to the white reference target 13. The white reference target 13 and the dark reference target 14 may alternatively be arranged on the same side of the aperture 17. The dark reference target 14 is advantageously arranged to be outside of the irradiated area 15, such that the irradiated portion 10 does not reach the dark reference target 14 in its scanning motion. Configurations in which the dark reference target 14 is partly or completely arranged within the irradiated area 15 are also possible. The dark reference target 14 may for example be an area painted or coated in black. In the example of FIG. 4a, the dark reference target 14 spans the entire width of the inspection zone 4 and extends beyond the inspection zone 4 on the aperture element 18 on both sides of the inspection zone 4, in the transverse direction T. The dark reference target may alternatively be arranged to only partially cover the inspection zone 4 in the transverse direction. The dark reference target 14 may be arranged to only extend beyond the inspection zone 4 on one side, or to not extend beyond the inspection zone 4 at all.

An alternative configuration comprising an optional second elongated inspection zone is shown in FIG. 4b. This configuration is similar to the one shown in FIG. 4a, except that in this example, the inspection system 1 comprises a first elongated inspection zone 4a and a second elongated inspection zone 4b which are arranged parallel to each other. The first and second elongated inspection zones 4a and 4b are arranged at a distance from each other in the direction T. Alternatively, the first and second elongated inspection zones 4a and 4b may be directly adjacent, or they may be partially overlapping in direction T. Inspection zones 4a and 4b have a respective longitudinal extension marked by arrows LEa and LEb, respectively, and respective transversal extensions marked by arrows TEa and TEb, respectively.

FIG. 4b shows an irradiation portion 10 which simultaneously covers the transversal extension of both the first 4a and the second 4b elongated inspection zones. In other words, during the scanning motion of the irradiated portion 10, the irradiated portion 10 irradiates corresponding parts of the first 4a and second 4b elongated inspection zones at the same time. The respective first irradiated ends 11 and second irradiated ends 12 of the first 4a and second 4b elongated inspection zones are at the same longitudinal position with respect to the irradiated area 15.

In the example configuration of FIG. 4b, the optional white reference target 13 and dark reference target 14 are arranged similarly to what was described in relation to FIG. 4a. It should be noted that, although one white reference target 13 and one dark reference target 14 are depicted, each spanning both the first 4a and the second 4b elongated inspection zone, there could alternatively be separate white reference targets for the first 4a and second 4b elongated inspection zones, and/or separate dark reference targets for the first 4a and second 4b elongated inspection zones. In yet another alternative, only one, or none, of the first 4a and second 4b elongated inspection zone may be provide with a white reference target 13. Only one, or none, of the first 4a and second 4b elongated inspection zone may be provided with a dark reference target 14.

FIG. 4c shows another example configuration in which the inspection system 1 has ten elongated inspection zones 4c-4l. The ten elongated inspection zones 4c-4l are arranged parallel to each other and are distributed in the transportation direction T, i.e. the direction transverse to the longitudinal extension of the elongated inspection zones. In FIG. 4c, only elongated inspection zone 4c and elongated inspection zones 4k and 4l are shown. The remaining elongated inspection zones 4d-4j are arranged between elongated inspection zones 4c and 4k. The depicted inspection zones 4c, 4k and 4l have respective longitudinal extensions marked by arrows LEc, LEK and LEI, respectively, and respective transversal extensions marked by arrows TEc, TEK and TEI, respectively.

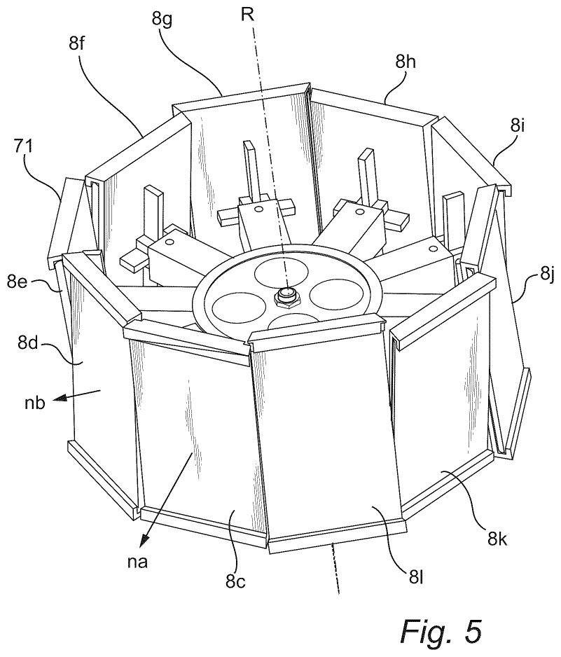

Each elongated inspection zone 4c-4l is successively irradiated in a scanning motion such that respective irradiated portion 10c-10l move from respective first irradiated ends 11c-11l to second irradiated ends 12c-12l. This is achieved by means of a polygon mirror 71 having reflective surfaces 8c-8l which have different orientations with respect to the rotation axis R of the polygon mirror 71. The specific order in which the elongated inspection zones 4c-4l are irradiated depends on the order in which the corresponding reflective surfaces 8c-8l are arranged around the rotation axis R on the polygon mirror 71. For more details on the polygon mirror 71, reference is made to FIG. 5.

In the example of FIG. 4c, the elongated inspection zones are shown to be separated by a separation distance, i.e. there is no overlap between neighboring inspection zones. Alternatively, some or all of the respective neighboring elongated inspections zones may be directly adjacent (i.e. touching each other) in direction T. Neighboring elongated inspection zones may also be partially overlapping. Respective pairs of neighboring elongated inspection zones may all be separated by the same distance, or by different distances.

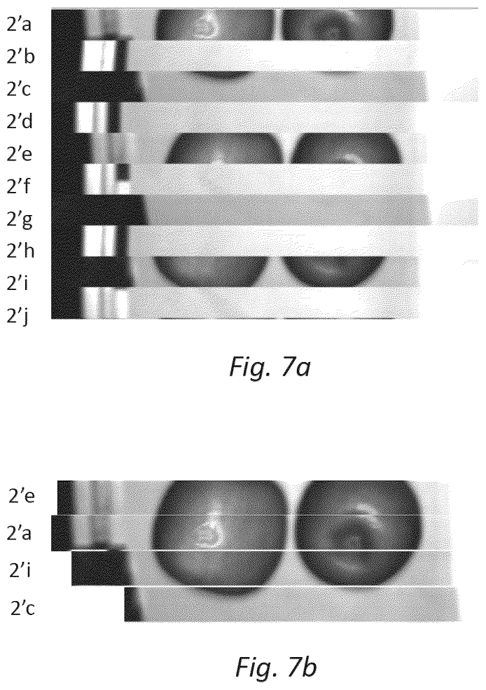

The camera 6 (not shown in FIG. 4c) is configured to provide sequences of images of the respective elongated inspection zone 4c-4l. Images from the respective sequences may be rearranged and combined to provide a resulting image of objects 2 passing through the inspection area 3. For an example of such a resulting image, reference is made to FIG. 7.

An example of a polygon mirror 71 used in the configuration of FIG. 4c will now be discussed in more detail with FIG. 5 as a starting point. The scanning element 136 comprises a set of reflective surfaces 8c, 8d, . . . 8l arranged one after another around a first rotation axis R around which the scanning element 71 is configured to rotate. Thus, by rotating the scanning element 71 around the first rotation axis R, the optical radiation originating from the irradiation arrangement 5 can be redirected to different part of the inspection area in the direction T, thus obtaining the different irradiated areas 15c-15l shown in FIG. 4c. The polygon mirror 71 has a set of surface normals na, nb, . . . describing the orientation of each respective reflective surface 8c, 8d, . . . 8l of the set of reflective surfaces 8c, 8d, . . . 8l of the polygon mirror. Said surface normals na, nb, . . . may be respective center surface normals, meaning surface normals at the respective center of each reflective surface. The orientation of each reflective surface may be described using the relative angle between each surface normal and a respective nominal surface normal defined as substantially orthogonal to the rotation axis R; such relative angle is henceforth referenced as the inclination angle α. For a surface normal which is orthogonal to said rotation axis in all directions, the inclination angle α is 0 degrees.

In general, the respective inclination angles may be selected from an interval of ±1°, ±2°, ±3°, ±4°, ±5°, ±6°, ±7°, ±8°, ±9°, ±10°, ±15°, ±20°, or ±40°.

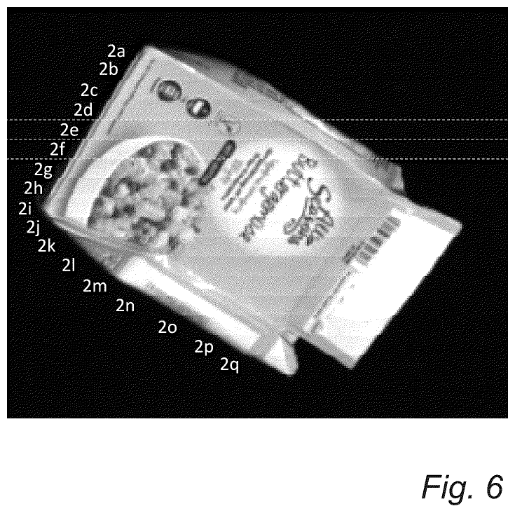

FIG. 6 shows an example of a sequence of images 2a-2q of an object 2 obtained by an inspection system 1 according to the present invention. The object 2, an empty food container, passed through the inspection area, for example transported on a conveyor system 108 as discussed in relation to FIG. 1, in direction T. Each image in the sequence of images 2a-2q was captured at a respective time when a respective part of the object 2 was in the inspection zone 4 (see FIG. 4a). Arranging the images 2a-2q in order next to each other results in a global image of the object 2. The delimitation between images 2d and 2e, 2e and 2f, and 2f and 2g, respectively, has been highlighted by a dashed line. As can be seen in FIG. 5, each image 2a-2q in the sequence of images thus represent a strip of equal width in direction T.

It should be emphasized that each image 2a-2q in the sequence of images was taken at a different point in time. More specifically, image 2a was captured by the camera 6 with an exposure between points in time t1 and t2, when the object had just reached the inspection zone 4. Image 2b, was captured by the camera 6 with an exposure between points in time t2 and t3; image 2c was captured by the camera with an exposure between points in time t3 and t4, etc. These time intervals, i.e. the exposure time of the images, correspond to the time required by the irradiation spot 10 to travel between the first irradiated end 11 and the second irradiated end 12 of the elongated inspection zone 4. For a given rotational speed of the polygon mirror 7, the exposure time of the images is thus constant. In other words, the exposure time of all images 2a-2q was the same. The transportation speed of the object 2 through the inspection area 3 and the rotational speed of the polygon mirror, i.e. the scanning speed and thus the exposure time, may advantageously be coordinated to ensure that no loss of information occurs. For example, if the transportation speed is too high in relation to the scanning speed, parts of the object 2 may be missing between two consecutive images in the sequence of images.

FIG. 7a shows images captured in different inspection zones 4c-4l, i.e with a configuration such as described in relation to FIG. 4c. Depending on the order with which reflective surfaces with different orientations are arranged on the polygon mirror 71, the images may be “spatially” unordered if provided in chronological order of capture, as in FIG. 7a. FIG. 7b shows the result after having rearranged the images in the correct order.

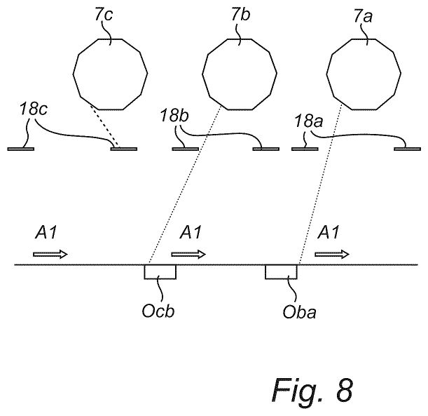

FIG. 8 schematically shows an example of how polygon mirrors of respective inspection systems may be arranged in a system comprising multiple inspection systems. The respective polygon mirrors of the inspection systems are arranged so the respective irradiated portions of the inspection systems are spatially separated from each other when moving from the respective first irradiated end to the second irradiated end of the respective elongated inspection zones.

In general, for an inspection system according to the present inventive concept, the length of the inspection area may be 600 mm. The inspection system may thus be arranged such that any objects travelling on a conveyor system 108 having a width of 600 mm are detected by the inspection system. A person skilled in the art realizes that the present invention by no means is limited to the embodiments described above. Hence, for an inspection system according to the present inventive concept, the length of the inspection area may be 1200 mm.

A system comprising multiple inspection systems, for example three inspection systems as illustrated in FIG. 8, allows a wider conveyor system to be used without loss of information. The respective polygon mirrors 7a, 7b, 7c are arranged such that the inspection areas are aligned and the respective irradiated portions move in the same direction A1 along the longitudinal extensions of the respective elongated inspection zones. As an example, a system comprising three inspection systems may have a resulting inspection area having a length of 3×600 mm=1.8 m. A system comprising five inspection systems may have a resulting inspection area having a length of 3 m.

In practice, the respective inspection systems in a system comprising multiple inspection systems may be arranged such that there in an overlap between the respective elongated inspection zones. As an example, the overlap area between the respective elongated inspection zones of two adjacent inspection systems may be 10%-20% of the length of an elongated inspection zone. Such overlap areas Oba and Ocb are illustrated in FIG. 8. A person skilled in the art realizes that the present invention by no means is limited to the embodiments described above. Hence, for handling of smaller objects such as polymer flakes, the overlap area between the respective elongated inspection zones of two adjacent inspection systems may be 1%-10% of the length of an elongated inspection zone.

The respective polygon mirrors may be arranged to rotate at the same speed. In other words, the scanning speed is the same for each inspection system. The polygon mirrors however rotate with a time offset. During the time that the irradiation spot coming from polygon mirror 7a is in the overlap area Oba, the irradiation spot coming from polygon mirror 7b is scanning on the aperture element 18b. The irradiation spot coming from polygon mirror 7b starts scanning in the overlap area Ocb when the irradiation spot coming from polygon mirror 7a leaves the overlap area Oba. The system is arranged with a similar time offset between polygon mirror 7c and polygon mirror 7b. Where more than three inspection systems are used, the same principle can be applied, with a first polygon mirror being the pace setter, and each subsequent polygon mirror being arranged with a time offset in relation to its neighbor.

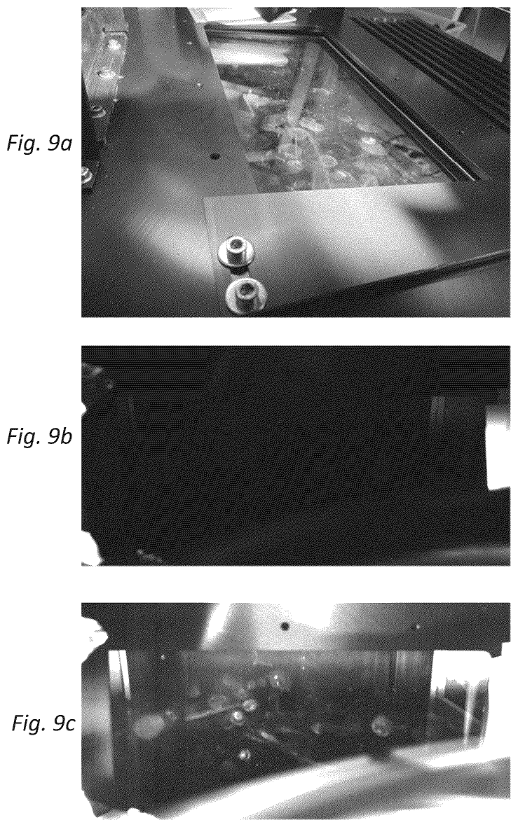

FIG. 9a is a photography of the aperture element with the optical window contaminated with some dust and fingerprints taken by a handheld camera from the side of the inspection system. FIG. 9b shows an image of the same optical window obtained by the camera of the inspection system. In this image, details are difficult to discern with the naked eye. However, FIG. 9c shows the image of FIG. 9b after image processing. The contamination is clearly visible in FIG. 9c, showing that information about the contamination of the optical window is present in the image of FIG. 9b, even though image processing is needed to reveal it more clearly.

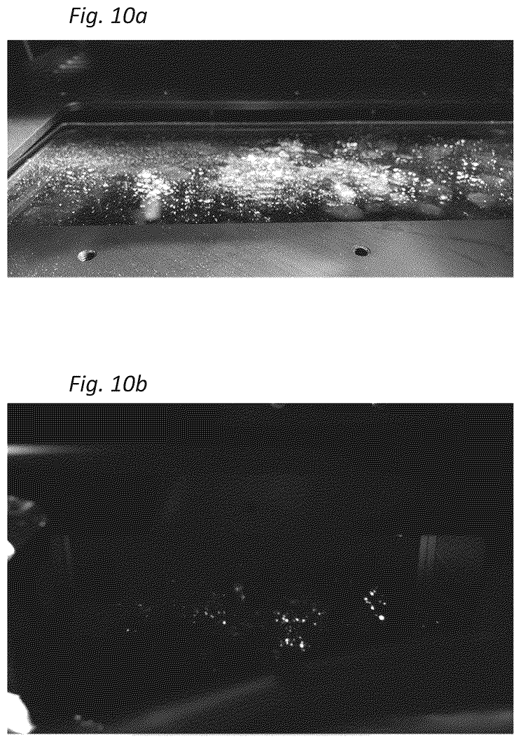

FIG. 10a is a photography taken by a handheld camera showing strong contamination on the optical window. FIG. 10b is an image obtained of the same optical window obtained by the camera of the inspection system, similar to the one shown in FIG. 9b. This shows that high levels of contamination of the optical window can be detected by the camera of the inspection system without additional image processing.

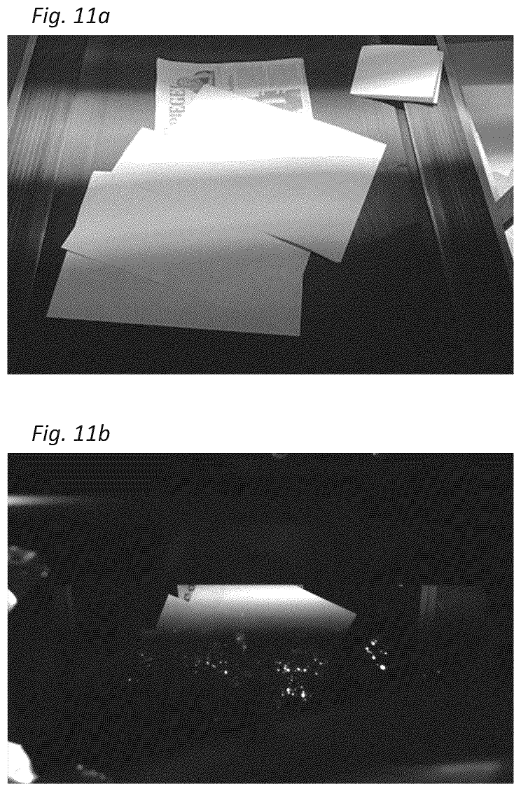

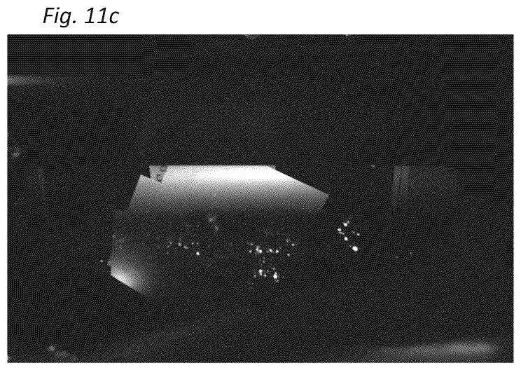

FIG. 11a is a photography, taken by a handheld camera, of the inspection area showing a newspaper and some paper sheets on the conveyor. The area illuminated by the irradiation arrangement is clearly visible in the photography. There is ambient light, and areas other than the area illuminated by the irradiation arrangement are also visible in the photography. FIG. 11b is an image of the inspection area shown in FIG. 11a obtained by the camera of the inspection system. The ambient light is not readily visible in FIG. 11b. Some contamination on the optical window is visible in FIG. 11b. However, contamination is difficult to see against the light background of the sheets of paper. FIG. 11c is another image of the inspection area shown in FIG. 11a obtained by the camera of the inspection system. Here, a flashlight has been directed towards the inspection area and the light from the flashlight is clearly visible in FIG. 11c. This illustrates that strong external light pollution is detectable even when the irradiation arrangement is switched on.

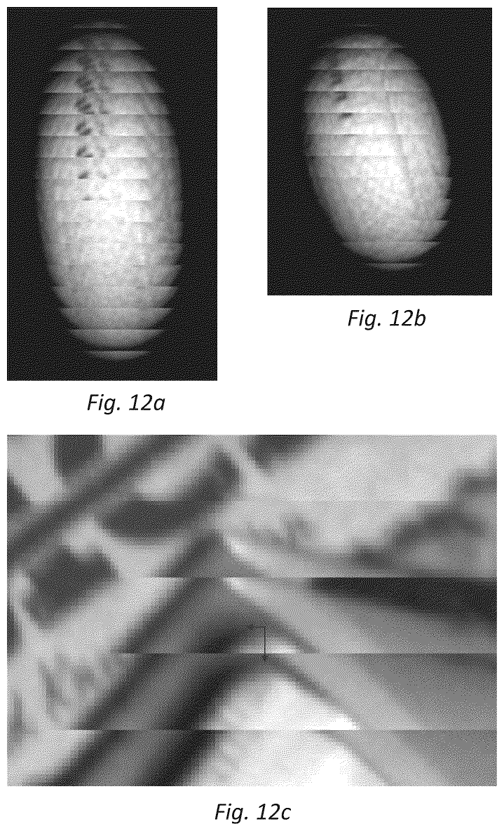

FIG. 12a show examples of a sequence of images of a moving ball obtained by an inspection system according to the present invention. FIG. 12b shows a sequence of images in which a ball is rolling to the right. FIG. 12c illustrates the estimation of a motion vector. On conveyor belts, the objects are typically not faster than the conveyer belt, therefore, all parts of the objects are detected by the camera, potentially several times. For slow objects, block matching techniques might be used for motion estimation. Movements sideways lead to an offset between detected image slices and are only visible in a silhouette or local textures. These estimations can be used to eject moving objects, in the simplest form by adapting the blow window of the valves to these estimations.

The movement estimations can also be used to reconstruct an image of the non-moving object, which might be beneficial for the classification of the object. As an alternative, the deep learning model which is trained to classify objects can be trained on data which introduces artificial movement artifacts in the augmentation step.

In addition, a strong presence of motion indicates that the infeed of the sorting machine is not optimal, e.g. conveyor belt speed, conveyor belt length and/or object type is not optimal. Therefore, the movement information is valuable for the customer to identify optimization potential in a sorting plant.

A person skilled in the art realizes that the present invention by no means is limited to the embodiments described above. The skilled person realizes that the inspection system may be provided with a tilting mirror instead of a polygon mirror. Such a tilting mirror is normally rotated back and forth between two end positions, where the rotation from one of the end positions to the other redirects optical radiation originating from said irradiation arrangement towards a portion only of said inspection area, which irradiated portion moves along said longitudinal extension of said at least a first elongated inspection zone from a first irradiated end to a second irradiated end of said at least a first elongated inspection zone once per rotation of the tilting mirror between said two end positions.

The system may be configured such that images of said at least a first elongated inspection zone are taken during both directions of rotation, or during only one of them.

However, the movement/velocity of a tilting mirror is not as constant as that of a polygon mirror, as it requires an acceleration and deceleration to change direction, resulting in an uneven distribution of light over the extension of the elongated inspection zone during the exposure time of an image.

The features of the embodiments may be combined in different ways, and many variants and modifications are possible within the scope of the amended claims. The word “comprising” does not exclude other elements or steps, and the indefinite articles “a” and “an” preceding an element do not exclude the presence of a plurality of such elements.

### Itemized List of Embodiments

Item 1. An inspection system (1) for inspecting objects (2) passing through an inspection area (3) comprising:
an irradiation arrangement (5) configured to emit optical radiation within a at least a first predetermined wavelength range,
a camera arrangement (16) comprising a camera (6) configured to provide a sequence of images of at least a first elongated inspection zone (4) having a longitudinal extension, which at least a first elongated inspection zone (4) comprises at least one elongated portion of said inspection area (3), and
a polygon mirror (7) configured to rotate around a rotation axis (R) and comprising a plurality of reflective surfaces (8) arranged one after another around said rotation axis (R),
   wherein
a field of view (9) of said camera (6) is static with respect to said inspection area (3),
   each reflective surface (8) of said polygon mirror (7) is further configured to redirect optical radiation originating from said irradiation arrangement towards a portion (10) only of said inspection area (3), which irradiated portion (10) moves along said longitudinal extension of said at least a first elongated inspection zone (4) from a first irradiated end (11) to a second irradiated end (12) of said at least a first elongated inspection zone (4) once per reflective surface (8) and revolution of said polygon mirror (7).
      Item 2. The inspection system (1) according to item 1, wherein the camera (6) is configured to capture said sequence of images at a predetermined frame rate, such that an exposure time of each image in said sequence of images corresponds to the time required for said irradiated portion (10) to move along the longitudinal extension of said at least a first elongated inspection zone (4) from the first irradiated end (11) to the second irradiated end (12) of the at least a first elongated inspection zone (4).
      Item 3. The inspection system (1) according to any one of the preceding items, further comprising a trigger element associated with each reflective surface (8) of the polygon mirror (7), wherein the system (1) is configured such that said trigger element triggers said camera to start the exposure of each image in said sequence of images when said irradiated portion is at the first irradiated end (11) of said at least a first elongated inspection zone (4), thus synchronizing said camera (6) and said polygon mirror (7).
      Item 4. The inspection system (1) according to any one of the preceding items, wherein said camera (6) is an area scan camera.
      Item 5. The inspection system (1) according to any one of the preceding item, wherein said camera arrangement further comprises an aperture element (18) having an aperture (17) delimiting said camera's field of view of said inspection area, which aperture element further comprises at least one of:
a white reference target (13) arranged in said at least a first elongated inspection zone (4) between said first and second irradiated ends (11, 12) of said at least a first elongated inspection zone (4), and
a dark reference target (14) arranged in said at least a first elongated inspection zone (4) before said first irradiated end (11) or after said second irradiated end (12) of said at least a first elongated inspection zone (4) along said longitudinal extension.
   Item 6. The inspection system according to item 5, wherein said aperture comprises an optical window and said camera is further configured to provide an image of one or both of:
a relevant first part of said field of view, thus enabling detection of contamination on said optical window; and
a relevant second part of said field of view, said image of a relevant second part of said field of view being optionally taken while said irradiation arrangement is switched off, thus enabling detection of external light pollution;
wherein said first part and said second part of said field of view are optionally the same.
   Item 7. The inspection system according to any one of the preceding items, further comprising a control unit configured to estimate motion of the objects and/or tracking a trajectory of the objects when the objects are passing through said at least one elongated inspection zone.
   Item 8. The inspection system according to any one of the preceding items, wherein said at least a first elongated inspection zone (4) comprises at least a first and a second elongated inspection zone (4a, 4b) and said camera is configured to provide a respective sequence of images of each one of said at least a first and a second elongated inspection zones.
   Item 9. The inspection system according to any one of the preceding items, wherein
said at least a first elongated inspection zone (4) comprises a plurality of elongated inspection zones (4a, 4b; 4c, 4d, 4e),
said polygon mirror (7) is configured to redirect said optical radiation towards each one said elongated inspection zones (4a, 4b; 4c, 4d, 4e) in said plurality of elongated inspection zones once per revolution of said scanning element,
each one of said plurality of reflective surfaces (8a-8j) is configured to redirect, once per revolution of said polygon mirror, said optical radiation towards a respective one of said plurality of elongated inspection zones (4a, 4b; 4c, 4d, 4e), and
said camera is configured to provide a respective sequence of images of each respective elongated inspection zone in said plurality of elongated inspection zones.
   Item 10. The inspection system according to item 9, wherein said polygon mirror has a set of surface normals (n), wherein each one of said surface normals is a center surface normal of a respective one of said plurality of reflective surfaces and wherein each one of said surface normals in said set of surface normals has a different inclination angle to said rotation axis compared to the other surface normals in said set of surface normals.
   Item 11. The inspection system according to any one of the preceding items, further comprising at least one additional irradiation arrangement configured to emit optical radiation within a second predetermined wavelength range towards said inspection area.
   Item 12. The inspection system according to any one of the preceding items, further comprising a spectrometer system (20) having at least one detector (21), which at least one detector is configured to receive and detect optical radiation within a predetermined detection wavelength, which optical radiation is at least one of emitted, reflected and scattered by and/or transmitted through an object (2) passing through said inspection area (3), wherein said at least one detector (21) is preferably a spectrometer adapted to detect optical radiation selected from the group comprising UV, visible light, IR, NIR, or a combination thereof.
   Item 13. A system comprising multiple inspection systems, each inspection system being configured according to any one of the preceding items, wherein the respective polygon mirrors of the inspection systems are arranged so the respective irradiated portions of the inspection systems are spatially separated from each other when moving from the respective first irradiated end to the second irradiated end of the respective elongated inspection zones.
   Item 14. A method for inspecting objects passing through an inspection area (3) by an inspection system according to any one of the preceding items wherein the method comprises:
redirecting, by a reflective surface (8) of said polygon mirror, optical radiation originating from said irradiation arrangement (5) towards a portion (10) of said inspection area,
rotating said polygon mirror (8) causing said irradiated portion to move along said longitudinal extension of said at least a first elongated inspection zone from said first irradiated end to said second irradiated end of said at least a first elongated inspection zone once per reflective surface and revolution of said polygon mirror, and
providing, by said camera, a sequence of images of said at least a first elongated inspection zone.
   Item 15. The method according to item 14, further comprising capturing, by said camera, said sequence of images at a predetermined frame rate, such that an exposure time of each image in said sequence of images corresponds to the time required for said irradiated portion to move along the longitudinal extension of said at least a first elongated inspection zone from the first irradiated end to the second irradiated end of the at least a first elongated inspection zone.
   Item 16. The method according to item 14 or 15, further comprising performing a white reference calibration for each image in said sequence of images, said white reference calibration being performed with respect to a white reference target arranged in said at least a first elongated inspection zone.
   Item 17. The method according to any one of items 14 to 16, wherein said inspection area further comprises at least a second elongated inspection zone and the method further comprises providing respective sequences of images of each one of said at least a first and a second elongated inspection zones.
   Item 18. The method according to any one of items 14 to 17, wherein said inspection system further comprises a spectrometer system having at least one detector configured to receive and detect optical radiation within a predetermined detection wavelength range, which optical radiation is at least one of emitted, reflected and scattered by and/or transmitted through an object passing through said inspection area, the method further comprising redirecting said optical radiation towards said at least one detector, wherein said optical radiation is preferably redirected via said polygon mirror.
   Item 19. The method according to any one of items 14 to 18, wherein said camera arrangement comprises an aperture element having an aperture delimiting said camera's field of view of said inspection area, said aperture comprising an optical window, the method further comprising:
providing, by said camera, an image of a relevant first part of said field of view, and
analyzing said image of said first part of said field of view to detect contamination on said optical window.
   Item 20. The method according to item 19, further comprising:
providing, by said camera, an image of a relevant second part of said field of view, wherein said first part and said second part of said field of view are optionally the same, and
analyzing said image of said second part of said field of view to detect external light pollution,
wherein the method optionally further comprises switching off said irradiation arrangement before said image of said second part of said field of view is taken.
   Item 21. A sorting system comprising:
an inspection system according to any one of items 1 to 12 or a system according to item 13,
transportation means for transporting said objects through said inspection area, wherein said transportation means is selected from a group comprising a conveyor belt, a chute or slide, a free fall path, and combinations thereof,
an ejection arrangement for ejecting and sorting said objects into at least two different destinations, wherein said ejection arrangement is selected from a group comprising a robotic arm, mechanical fingers, air valves or nozzles, a conveyor belt, and combinations thereof.
   Item 22. The sorting system according to item 21, further comprising a control unit configured to estimate motion of the objects and/or tracking a trajectory of the objects when the objects are passing through said at least one elongated inspection zone,
wherein said control unit is configured to control said transportation means and/or said ejection arrangement based on said estimated motion and/or tracked trajectory.

1. An inspection system for inspecting objects passing through an inspection area comprising:
an irradiation arrangement configured to emit optical radiation within a at least a first predetermined wavelength range,
a camera arrangement comprising a camera configured to provide a sequence of images of at least a first elongated inspection zone having a longitudinal extension and a transversal extension, which at least a first elongated inspection zone comprises at least one elongated portion of said inspection area, and
a polygon mirror configured to rotate around a rotation axis and comprising a plurality of reflective surfaces arranged one after another around said rotation axis,
wherein
a field of view of said camera is static with respect to said inspection area,
each reflective surface of said polygon mirror is further configured to redirect optical radiation originating from said irradiation arrangement towards a portion only of said inspection area, which irradiated portion moves along said longitudinal extension of said at least a first elongated inspection zone from a first irradiated end to a second irradiated end of said at least a first elongated inspection zone once per reflective surface and revolution of said polygon mirror,
wherein the camera is configured to capture said sequence of images at a predetermined frame rate, such that an exposure time of each image in said sequence of images corresponds to the time required for said irradiated portion to move along the longitudinal extension of said at least a first elongated inspection zone from the first irradiated end to the second irradiated end of the at least a first elongated inspection zone,
wherein said camera has a plurality of sensor pixel lines and is configured to capture said images of said at least a first elongated inspection zone, wherein, during said capturing, said transversal extension of each one of said at least a first elongated inspection zone covers a plurality of sensor pixel lines,
wherein each image in said sequence of image is a representation of at least a portion of said objects when present in said at least a first elongated inspection zone,
wherein said irradiated portion covers the entire transversal extension of said at least a first elongated inspection zone.

2. The inspection system according to claim 1, wherein said irradiation arrangement is configured to provide a substantially uniform irradiation of said irradiated portion.

3. The inspection system according to claim 1, further comprising a trigger element associated with each reflective surface of the polygon mirror, wherein the system is configured such that said trigger element triggers said camera to start the exposure of each image in said sequence of images when said irradiated portion is at the first irradiated end of said at least a first elongated inspection zone, thus synchronizing said camera and said polygon mirror.

4. The inspection system according to claim 1, wherein said camera is an area scan camera.

5. The inspection system according to claim 1, wherein said camera arrangement further comprises an aperture element having an aperture delimiting said camera's field of view of said inspection area, which aperture element further comprises at least one of:
a white reference target arranged in said at least a first elongated inspection zone between said first and second irradiated ends of said at least a first elongated inspection zone, and
a dark reference target arranged in said at least a first elongated inspection zone before said first irradiated end or after said second irradiated end of said at least a first elongated inspection zone along said longitudinal extension.

6. The inspection system according to claim 5, wherein said aperture comprises an optical window and said camera is further configured to provide an image of one or both of:
a relevant first part of said field of view, thus enabling detection of contamination on said optical window; and
a relevant second part of said field of view, said image of a relevant second part of said field of view being optionally taken while said irradiation arrangement is switched off, thus enabling detection of external light pollution;
wherein said first part and said second part of said field of view are optionally the same.

7. The inspection system according to claim 1, further comprising a control unit configured to estimate motion of the objects and/or tracking a trajectory of the objects when the objects are passing through said at least one elongated inspection zone.

8. The inspection system according to claim 1, wherein said at least a first elongated inspection zone comprises at least a first and a second elongated inspection zone and said camera is configured to provide a respective sequence of images of each one of said at least a first and a second elongated inspection zones.

9. The inspection system according to claim 1, wherein
said at least a first elongated inspection zone comprises a plurality of elongated inspection zones,
said polygon mirror is configured to redirect said optical radiation towards each one said elongated inspection zones in said plurality of elongated inspection zones once per revolution of said scanning element,
each one of said plurality of reflective surfaces is configured to redirect, once per revolution of said polygon mirror, said optical radiation towards a respective one of said plurality of elongated inspection zones, and
said camera is configured to provide a respective sequence of images of each respective elongated inspection zone in said plurality of elongated inspection zones.

10. The inspection system according to claim 9, wherein said polygon mirror has a set of surface normals, wherein each one of said surface normals is a center surface normal of a respective one of said plurality of reflective surfaces and wherein each one of said surface normals in said set of surface normals has a different inclination angle to said rotation axis compared to the other surface normals in said set of surface normals.

11. The inspection system according to claim 1, further comprising at least one additional irradiation arrangement configured to emit optical radiation within a second predetermined wavelength range towards said inspection area.

12. The inspection system according to claim 1, further comprising a spectrometer system having at least one detector, which at least one detector is configured to receive and detect optical radiation within a predetermined detection wavelength, which optical radiation is at least one of emitted, reflected and scattered by and/or transmitted through an object passing through said inspection area, wherein said at least one detector is preferably a spectrometer adapted to detect optical radiation selected from the group comprising UV, visible light, IR, NIR, or a combination thereof.

13. The inspection system according to claim 1, further comprising at least one preprocessing unit configured to receive calibration information and to compensate each image in said sequence of images based on said calibration information using a white reference target arranged in said at least a first elongated inspection zone.

14. The inspection system according to claim 1, further comprising at least one image processing unit configured to combine the images in said sequence of images to form an output comprising a representation or a hyperspectral representation of at least one object passing through said inspection area.

15. A system comprising multiple inspection systems, each inspection system being configured according to claim 1, wherein the respective polygon mirrors of the inspection systems are arranged so the respective irradiated portions of the inspection systems are spatially separated from each other when moving from the respective first irradiated end to the second irradiated end of the respective elongated inspection zones.

16. A method for inspecting objects passing through an inspection area wherein the method comprises:
providing:
at least a first elongated inspection zone comprising at least a portion of said inspection area, said at least a first elongated inspection zone having a longitudinal extension and a transversal extension,
at least one object and passing said at least one object through said inspection area,
an irradiation arrangement configured to emit optical radiation within at least a first wavelength range,
a camera arrangement comprising a camera having a plurality of sensor pixel lines, and where a field of view of said camera is static with respect to said inspection area,
a polygon mirror configured to rotate around a rotation axis and comprising a plurality of reflective surfaces arranged one after another around said rotation axis,
at least one image processing unit,
emitting, by said irradiation arrangement, optical radiation within said at least a first predetermined wavelength range,
redirecting, by a respective one of said reflective surfaces of said polygon mirror, optical radiation originating from said irradiation arrangement towards a portion only of said inspection area, wherein said irradiated portion covers the entire transversal extension of said at least a first elongated inspection zone,
rotating said polygon mirror and thereby causing said irradiated portion to move along said longitudinal extension of said at least a first elongated inspection zone from a first irradiated end to a second irradiated end of one of, or all of, said at least a first elongated inspection zone once per reflective surface and revolution of said polygon mirror,
capturing, by said camera, a sequence of images of said at least a first elongated inspection zone, where
during said capturing, said transversal extension of each one of said at least a first elongated inspection zone covers a plurality of said sensor pixel lines,
each image in said sequence of images is a representation of at least a portion of said objects when present in said at least a first elongated inspection zone,
each image in said sequence of images is captured with an exposure time corresponding to the time required for said irradiated portion to move along the longitudinal extension of one of said at least a first elongated inspection zone from said first irradiated end to said second irradiated end of said at least a first elongated inspection zone, and
combining, by said at least one image processing unit, the images in said sequence of images to form an output comprising a representation of the at least one object passing through said inspection area.

17. The method according to claim 16, further comprising performing a white reference calibration for each image in said sequence of images, said white reference calibration being performed with respect to a white reference target arranged in said at least a first elongated inspection zone.

18. The method according to claim 16, wherein said inspection area further comprises at least a second elongated inspection zone and the method further comprises providing respective sequences of images of each one of said at least a first and a second elongated inspection zones.

19. The method according to claim 16, wherein said inspection system further comprises a spectrometer system having at least one detector configured to receive and detect optical radiation within a predetermined detection wavelength range, which optical radiation is at least one of emitted, reflected and scattered by and/or transmitted through an object passing through said inspection area, the method further comprising redirecting said optical radiation towards said at least one detector, wherein said optical radiation is preferably redirected via said polygon mirror.

20. The method according to claim 16, wherein said camera arrangement comprises an aperture element having an aperture delimiting said camera's field of view of said inspection area, said aperture comprising an optical window, the method further comprising:
providing, by said camera, an image of a relevant first part of said field of view, and
analyzing said image of said first part of said field of view to detect contamination on said optical window.

21. The method according to claim 20, further comprising:
providing, by said camera, an image of a relevant second part of said field of view, wherein said first part and said second part of said field of view are optionally the same, and
analyzing said image of said second part of said field of view to detect external light pollution,
wherein the method optionally further comprises switching off said irradiation arrangement before said image of said second part of said field of view is taken.

22. A method according to claim 16, wherein the method is performed by an inspection system that includes at least one image processing unit configured to combine the images in said sequence of images to form an output comprising a representation or a hyperspectral representation of at least one object passing through said inspection area and/or a system wherein the respective polygon mirrors of the inspection systems are arranges so the respective irradiated portions of the inspection systems are spatially separated from each other when moving from the respective first irradiated end to the second irradiated end of the respective elongated inspection zones.

23. A sorting system comprising:
the inspection system according to claim 14,
transportation means for transporting said objects through said inspection area, wherein said transportation means is selected from a group comprising a conveyor belt, a chute or slide, a free fall path, and combinations thereof,
an analysis unit configured to receive said output of said processing unit and analyze said representation of at least one object passing through said inspection area,
an ejection arrangement for ejecting and sorting said objects into at least two different destinations based on said analysis of said representation, wherein said ejection arrangement is selected from a group comprising a robotic arm, mechanical fingers, air valves or nozzles, a conveyor belt, and combinations thereof.

24. The sorting system according to claim 23, further comprising a control unit configured to estimate motion of the objects and/or tracking a trajectory of the objects when the objects are passing through said at least one elongated inspection zone,
wherein said control unit is configured to control said transportation means and/or said ejection arrangement based on said estimated motion and/or tracked trajectory.
